(19) United States
(12) Patent Application Publication
(10) Pub. No.: US 2024/0214379 A1
(43) Pub. Date: Jun. 27, 2024

(54) DEVICE CONTROL PERMISSION SETTING METHOD AND APPARATUS, AND COMPUTER DEVICE AND STORAGE MEDIUM

(71) Applicant: SHENZHEN TCL NEW TECHNOLOGY CO., LTD., Shenzhen (CN)

(72) Inventor: Hui LI, Shenzhen (CN)

(73) Assignee: SHENZHEN TCL NEW TECHNOLOGY CO., LTD., Shenzhen (CN)

(21) Appl. No.: 18/401,315

(22) Filed: Dec. 29, 2023

Related U.S. Application Data
(63) Continuation of application No. PCT/CN2022/100750, filed on Jun. 23, 2022.

(30) Foreign Application Priority Data
Jul. 26, 2021 (CN) 202110846385.3

(51) Int. Cl. H04L 9/40; H04L 67/12; H04L 67/141

(52) U.S. Cl. CPC H04L 63/0876; H04L 67/12; H04L 67/141

(57) ABSTRACT

The present application provides a configuration method for a device control privilege, an apparatus, a device, and a storage medium. Access information for a second cloud server sent by a second internet of things device that has established a connection relationship with a first internet of things device is received, and device authentication information of the second cloud server is obtained according to said access information; authentication is performed on the second cloud server on the basis of the device authentication information; and if authentication is passed, privilege information of the second internet of things device with respect to the first internet of things device is configured.

### CROSS-REFERENCE TO RELATED APPLICATION

This application claims priority to Chinese Patent Application No. 202110846385.3, filed on Jul. 26, 2021, entitled “DEVICE CONTROL PERMISSION SETTING METHOD AND APPARATUS, AND COMPUTER DEVICE AND STORAGE MEDIUM”, the disclosure of which is incorporated herein by reference in its entirety.

### TECHNICAL FIELD

The present application relates to the field of Internet technologies, and more particularly to a method and apparatus for setting a device control authority, a computer device, and a storage medium.

### BACKGROUND

The Internet of Things (IoT), i.e., Internet of Everything, is a huge network formed by combining various information sensing devices with a network, so that interconnection and intercommunication between people, machines, and objects can be realized at anytime, anywhere. An Internet of Things device is composed of a hardware and a software system thereon, and device control of the Internet of Things device can be realized by setting a device control authority of the Internet of Things device.

### SUMMARY

In a first aspect, an embodiment of the present application provides a method for setting a device control authority applied to a first Internet of Things device, including:
receiving access information for a second cloud server transmitted by a second Internet of Things device that has established a connection relationship with the first Internet of Things device, where the first Internet of Things device and the second Internet of Things device belong to different Internet of Things systems, and the second cloud server is a cloud server having a trust relationship with the second Internet of Things device;
obtaining device authentication information of the second cloud server according to the access information;
authenticating the second cloud server based on the device authentication information; and
in response to the authentication being passed, setting authority information of the second Internet of Things device for the first Internet of Things device.

Correspondingly, yet another embodiment of the present application further provides a storage medium on which a computer program is stored, where the computer program, when executed by a processor, implements the method for setting the device control authority as shown in any one of the first aspect, the second aspect, and the third aspect, or in any one of alternative embodiments of any one of the first aspect, the second aspect, and the third aspect.

Correspondingly, another embodiment of the present application further provides a computer device, including: a memory, a processor, and a computer program stored on the memory and operable on the processor, where the computer program, when executed by the processor, implements the method for setting the device control authority as shown in any one of the first aspect, the second aspect, and the third aspect, or in any one of alternative embodiments of any one of the first aspect, the second aspect, and the third aspect.

Embodiments of the present application can receive access information for a second cloud server transmitted by a second Internet of Things device that has established a connection relationship with the first Internet of Things device, where the first Internet of Things device and the second Internet of Things device belong to different Internet of Things systems, and the second cloud server is a cloud server having a trust relationship with the second Internet of Things device; obtain device authentication information of the second cloud server according to the access information; authenticate the second cloud server based on the device authentication information; and in response to the authentication being passed, set authority information of the second Internet of Things device for the first Internet of Things device.

### DESCRIPTION OF THE DRAWINGS

FIG. 1 is a schematic diagram of a scenario of a method for setting a device control authority according to some embodiments of the present application.

FIG. 2 is a flow diagram of a method for setting a device control authority according to some embodiments of the present application.

FIG. 3 is an interactive schematic diagram of a method for setting a device control authority according to some embodiments of the present application.

FIG. 4 is another interactive schematic diagram of a method for setting a device control authority according to some embodiments of the present application.

FIG. 5 is another interactive schematic diagram of a method for setting a device control authority according to some embodiments of the present application.

FIG. 6 is another interactive schematic diagram of a method for setting a device control authority according to some embodiments of the present application.

FIG. 7 is another flow diagram of a method for setting a device control authority according to some embodiments of the present application.

FIG. 8 is another interactive schematic diagram of a method for setting a device control authority according to some embodiments of the present application.

FIG. 9 is a schematic structural diagram of a computer device according to some embodiments of the present application.

### DETAILED DESCRIPTION

Technical solutions in embodiments of the present application will be clearly and completely described below in conjunction with drawings in the embodiments of the present application. Obviously, the described embodiments are only a part of embodiments of the present application, rather than all the embodiments. Based on the embodiments in the present application, all other embodiments obtained by those skilled in the art without creative work fall within the protection scope of the present application.

Embodiments of the present application provide a method and apparatus for setting a device control authority, a computer device, and a storage medium. Specifically, an embodiment of the present application provides an apparatus for setting a device control authority applicable to a first computer device (which may be referred to as a first setting apparatus for distinguishing), an apparatus for setting a device control authority applicable to a second computer device (which may be referred to as a second setting apparatus for distinguishing), and an apparatus for setting a device control authority applicable to a third computer device (which may be referred to as a third setting apparatus for distinguishing).

The first computer device may be a device such as a terminal, which may be a mobile phone, a tablet computer, a notebook computer, an Internet of Things device, or the like. For example, the Internet of Things device may include an intelligent sound box, an intelligent television, an intelligent refrigerator, an intelligent water heater, or the like. The second computer device may be a device such as a terminal, which may be a mobile phone, a tablet computer, a notebook computer, an Internet of Things device, or the like. For example, the Internet of Things device may include an intelligent sound box, a gateway, an intelligent television, a router, or the like. The third computer device may be a device such as a server, which may be a single server or a cluster of servers composed of a plurality of servers, where the plurality of servers may be composed of a blockchain and the servers are nodes on the blockchain.

An example in which the first computer device is used as one terminal, the second computer device is used as another terminal, and the third computer device is a server is taken in any one of the embodiments of the present application, to introduce a method for setting a device control authority.

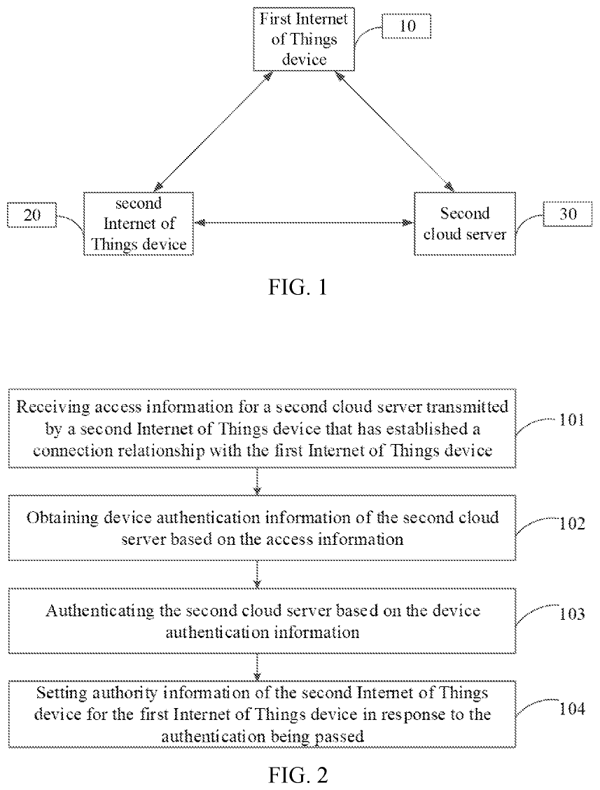

Referring to FIG. 1, an embodiment of the present application provides a system for setting a device control authority, including a first Internet of Things device 10, a second Internet of Things device 20, a second cloud server 30, and the like. The first Internet of Things device 10, the second Internet of Things device 20, and the second cloud server 30 are connected over a network, for example, through a wired or wireless network connection, or the like, where the apparatus for setting the device control authority is integrated in a terminal or a server. For example, the apparatus in the form of a client is integrated in a terminal or a server.

The second Internet of Things device 20 may transmit access information for the second cloud server 30 to the first Internet of Things device 10 that has established a connection relationship with the second Internet of Things device 20, where the access information is configured to establish an access connection relationship between the first Internet of Things device 10 and the second cloud server 30, the access connection relationship is configured for the second cloud server 30 to authenticate the first Internet of Things device 10, the second cloud server 30 is a cloud server having a trust relationship with the second Internet of Things device 20, and the second Internet of Things device 20 and the first Internet of Things device 10 belong to different Internet of Things systems. Correspondingly, the first Internet of Things device 10 may receive the access information for the second cloud server 30 transmitted by the second Internet of Things device 20 that has established the connection relationship with the first Internet of Things device 10.

Further, the first Internet of Things device 10 may obtain device authentication information of the second cloud server 30 according to the access information. For example, the first Internet of Things device 10 may transmit an access request to the second cloud server 30 based on the access information to establish an access connection relationship between the first Internet of Things device 10 and the second cloud server 30. As such, the first Internet of Things device 10 may obtain device authentication information of the second cloud server 30 based on the access connection relationship, and authenticate the second cloud server 30 based on the device authentication information.

It should be noted that the second cloud server 30 may also authenticate the first Internet of Things device 10. Specifically, the second cloud server 30 authenticates the first Internet of Things device 10 based on the access connection relationship between the second cloud server 30 and the first Internet of Things device 10. If the authentication is passed, the second cloud server 30 may transmit authentication result information of the first Internet of Things device 10 to the second Internet of Things device 20 to trigger the second Internet of Things device 20 to set authority information for the first Internet of Things device 10 based on the authentication result information.

Correspondingly, the second Internet of Things device 20 may receive authentication result information of the first Internet of Things device 10 transmitted by the second cloud server 30, and if the authentication result information is that the authentication is passed, the second Internet of Things device 20 may set its authority information for the first Internet of Things device 10. Also, if the first Internet of Things device 10 has authenticated the second cloud server 30, the first Internet of Things device 10 may set authority information of the second Internet of Things device 20 for the first Internet of Things device 10.

Detailed descriptions are given below. It should be noted that the description order of the following embodiments is not intended to limit the preferred order of the embodiments.

The present embodiment will be described from the perspective of a first setting apparatus, which may be specifically integrated in a terminal. For example, the first setting apparatus may be integrated in the first Internet of Things device.

A method for setting a device control authority provided in the embodiment of the present application can be performed by a processor of the terminal. As shown in FIG. 2, the method for setting the device control authority may include steps 101-104 as follows.

At step 101, access information for a second cloud server transmitted by a second Internet of Things device that has established a connection relationship with the first Internet of Things device may be received, where the first Internet of Things device and the second Internet of Things device belong to different Internet of Things systems, and the second cloud server is a cloud server having a trust relationship with the second Internet of Things device;

The Internet of Things refers to collecting in real time any object or process to be monitored, connected, or interacted by various devices and technologies, such as various information sensors, radio frequency identification technologies, global positioning systems, infrared sensors, or laser scanners, collecting various required information such as sound, light, heat, electricity, mechanics, chemistry, biology, or location of the object and process, realizing ubiquitous connection between one object and another object or between an object and human via various possible network access, and realizing intelligent sensing, identification, and management of the object and the process. The Internet of Things is an information carrier based on the Internet, as well as conventional telecommunications networks, etc., which enables all ordinary physical objects that can be independently addressed to form an interconnected and intercommunicated network.

The Internet of Things device refers to a physical device capable of accessing the Internet of Things (IOT), for example, a refrigerator, an air conditioner, a television, a robot vacuum cleaner, and an intelligent sound box. In particular, the Internet of Things device may be a terminal device such as a mobile phone, a tablet computer, a notebook computer, or the like on which a corresponding Internet of Things client may be run. As an example, the client may include a browser application (also referred to as a Web application), an Application (APP), an applet, and the like.

The Internet of Things system is an integrated system platform for realizing interconnection and intercommunication, and Internet of Things objects belonging to the same Internet of Things system can interact by following a data interaction criterion of the Internet of Things system. For example, compared with cross Internet of Things systems, for an Application (APP), a cloud server, an Internet of Things device, a service, and the like in the same Internet of Things system, they may have related authority of data interaction because they are Internet of Things objects in the same Internet of Things system, so that the Internet of Things objects in the same Internet of Things system may perform data interaction more quickly.

In a practical application, Internet of Things objects belonging to the same Internet of Things system may be referred to as Internet of Things object belonging to the same Internet of Things ecology, or Internet of Things objects belonging to the same ecology. For example, for an Internet of Things system including an application, a cloud server, an Internet of Things device, a service, and the like constructed by an organization subject, an Internet of Things object in the Internet of Things system may be considered as an Internet of Things object in an Internet of Things ecology constructed by the organization subject. The organization subject may be a single subject, for example, a manufacturer, a factory, a brand, or the like. The organization subject may be an organization formed by a plurality of subjects, for example, an alliance organization formed by negotiation of a plurality of manufacturers.

The first Internet of Things device in the present application is an Internet of Things device to be controlled by the second Internet of Things device. As an example, in an application scenario of an intelligent home, the first Internet of Things device may be an intelligent home appliance provided by a manufacturer A; and in an application scenario of intelligent security, the first Internet of Things device may be an intelligent security device provided by the manufacturer A; and so on.

The second Internet of Things device in the present application is an Internet of Things device of the first Internet of Things device is to be controlled, and the second Internet of Things device and the first Internet of Things device belong to different Internet of Things system. For example, for the first Internet of Things device, one case of the second Internet of Things device may be a third party local hub, where the “third party” is used to emphasize that the second Internet of Things device and the first Internet of Things device belong to different Internet of Things systems, for example, the second Internet of Things device and the first Internet of Things device are Internet of Things devices belonging to different manufacturers; and “local hub” is used to emphasize that the second Internet of Things device is a local device that can control and manage the first Internet of Things device.

The second cloud server in the present application is a cloud server having a trust relationship with the second Internet of Things device, so that the second Internet of Things device trusts the second cloud server. For example, the second Internet of Things device trusts a device authentication result of the second cloud server to the first Internet of Things device. For another example, the second Internet of Things device may specifically delegate authentication of the first Internet of Things device to the second Internet of Things device to the second cloud server for execution, and the like.

In the present application, a trust relationship between the second cloud server and the second Internet of Things device may be implemented in a plurality of manners; for example, the second cloud server and the second Internet of Things device may belong to the same Internet of Things system in which the second cloud server and the second Internet of Things device have a trust relationship; for another example, the second cloud server and the second Internet of Things device may belong to different Internet of Things systems, but a trust relationship is established between the second cloud server and the second Internet of Things device; and so on.

It should be noted that the Internet of Things system to which the second Internet of Things device belongs may be provided with an Internet of Things App for the second Internet of Things device, and the Internet of Things App and the first Internet of Things device belong to different Internet of Things systems. In some embodiments, the second Internet of Things device may be specifically a terminal device running the Internet of Things App, which may control the first Internet of Things device by performing steps in the method for setting the device control authority described in the present application. That is, the third party local hub may be in the form of a terminal device running the Internet of Things App in addition to the Internet of Things device. For example, the terminal device may include a mobile phone, a tablet computer, a notebook computer, and the like.

As an example, referring to FIG. 3, the first Internet of Things device may be an IoT device shown by 1001, and the second Internet of Things device may be a third party local hub shown by 1002, and the second cloud server may be a third party authentication center shown by 1003. The third party local hub and the third party authentication center belong to the same Internet of things system, and the Internet of Things device and the third party local hub belong to different Internet of things systems.

In this example, the IoT device may receive access information for a third party authentication center transmitted by a third party local hub that has established a connection relationship with the IoT device, where the third party local hub has a trust relationship with the third party authentication center, and in particular, the third party local hub may delegate one or more related steps for authenticating the first Internet of Things device to the third party authentication center for execution.

Referring to FIG. 3, in this example, the first Internet of Things device may further have a client that may interact with the first Internet of Things device. The client may belong to the same Internet of Things system as the first Internet of Things device, or may belong to a different Internet of Things system from the first Internet of Things device, such as the IoT App shown by 1004 of FIG. 3. The client may then have a corresponding cloud server, for example, a cloud server of the same IoT system to which the client belongs, such as the IoT cloud shown by 1005 of FIG. 3.

The access information transmitted by the second Internet of Things device to the first Internet of Things device is related information for the first Internet of Things device to access the second cloud server; for example, the access information may include access address information, and the first Internet of Things device may determine an access address of the second cloud server via the access address information; for another example, the access information may include access parameter information that may be used for the second cloud server to further process access requirements of the first Internet of Things device; and so on.

In the present application, before the first Internet of Things device receives the access information transmitted by the second Internet of Things device, the first Internet of Things device may establish a connection relationship between the first Internet of Things device and the second Internet of Things device, so that the access information for the second cloud server transmitted by the second Internet of Things device can be obtained based on the connection relationship. Specifically, the step of “receiving access information for the second cloud server transmitted by the second Internet of Things device that has established the connection relationship with the first Internet of Things device” can include:
establishing a control connection relationship with the second Internet of Things device;
corresponding, the step of “receiving access information for a second cloud server transmitted by a second Internet of Things device that has established a connection relationship with the first Internet of Things device” can include: receiving the access information for the second cloud server transmitted by the second Internet of Things device based on the connection relationship.

It should be noted that the connection relationship established here is a connection relationship in a configuration process. Specifically, a process in which the second Internet of Things device performs device control for the first Internet of Things device may include both configuration and control. The configuration process refers to steps having completed before steps required for implementation of control. For example, the configuration process may include steps such as network distribution and connection.

There may be multiple manners of establishing the connection relationship between the first Internet of Things device and the second Internet of Things device. For example, the connection relationship can be implemented by exchanging a key, for example, by exchanging a Personal Identification Number (PIN) code. Specifically, the first Internet of Things device and the second Internet of Things device may establish an encrypted connection relationship by performing security negotiation via a known PIN code.

As an example, the key exchanging solution may be implemented by PreSharedKey (PSK) as defined in the Datagram Transport Layer Security (DTLS). For another example, the key exchanging solution may be implemented in conjunction with an Elliptic Curve Diffie-Hellman key Exchange (ECDH) algorithm and the PIN code, and so on.

After the connection relationship between the first Internet of Things device and the second Internet of Things device is established, the device authentication information of the second Internet of Things device can be further obtained based on the connection relationship. As an example, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting device authentication information and receiving the device authentication information.

In some embodiments, taking into account such a case that the first Internet of Things device can correspond to a plurality of second Internet of Things devices to be established a connection relationship therewith to control the first Internet of Things device, the first Internet of Things device may determine a target second Internet of Things device from the plurality of second Internet of Things devices and establish a connection with the target second Internet of Things device. Specifically, the step of “establishing a connection relationship between the first Internet of Things device and the second Internet of Things device” can include:
receiving connection interrogation information transmitted by the second Internet of Things device; and
in response to information format of the connection interrogation information meeting a preset interrogation format, establishing a connection relationship between the first Internet of Things device and the second Internet of Things device.

The connection interrogation information is information transmitted by the second Internet of Things device, which is used to query whether the first Internet of Things device establishes a connection relationship with the second Internet of Things device. Formats of the connection interrogation information may include a variety of formats. For example, the connection interrogation information may in a form of a packet, such as a multicast packet, a broadcast packet, or the like.

In a practical application, the first Internet of Things device may receive the connection interrogation information transmitted by the second Internet of Things device after being in a network distribution state. For example, the first Internet of Things system may be configured with an Internet of Things App (which may be referred to as the first Internet of Things App for differentiation) for the first Internet of Things device, and a user may enable the first Internet of Things device to enter the network distribution state via the first Internet of Things App. For another example, the user may directly interact with the first Internet of Things device, for example, by triggering a physical control of the first Internet of Things device, or by voice calling to interact with the first Internet of Things device, so that the first Internet of Things device enters the network distribution state. For another example, the first Internet of Things device may always be in the network distribution state; and so on.

As an example, after entering the network distribution state, the first Internet of Things device may enter a mode of a pre-agreed listening port, so that the first Internet of Things device may listen for a broadcast packet in a local area network. Correspondingly, the second Internet of Things device may transmit a multicast packet or a broadcast packet in the local area network by means of the multicast packet or the like, so as to transmit the connection interrogation information to the first Internet of Things device. As such, the first Internet of Things device can receive the connection interrogation information transmitted by the second Internet of Things device.

In the present application, taking into account such a case that the first Internet of Things device can receive connection interrogation information transmitted by the plurality of second Internet of Things devices, a preset interrogation format can be set for the connection interrogation information in an application scenario in which device control is performed across Internet of things systems. As such, if the connection interrogation information of one of the second Internet of Things devices received by the first Internet of Things device meets the preset interrogation format, a connection relationship between the first Internet of Things device and the second Internet of Things device is established.

In one embodiment, after the first Internet of Things device has received the connection interrogation request transmitted by the second Internet of Things device and meeting the preset interrogation format, the first Internet of Things device may generate interrogation response information for the connection interrogation information, so that the second Internet of Things device may be informed of a response of the first Internet of Things device to the connection interrogation information by transmitting the interrogation response information to the second Internet of Things device. As such, both the first Internet of Things device and the second Internet of Things device may determine the connection relationship between the first Internet of Things device and the second Internet of Things device to be established. In this consensus, the first Internet of Things device and the second Internet of Things device may establish the connection relationship between the first Internet of Things device and the second Internet of Things device. Specifically, “establishing a connection relationship between the first Internet of Things device and the second Internet of Things device” can include:
generating interrogation response information based on the connection interrogation information, where the interrogation response information includes device information of the first Internet of Things device; and
transmitting the interrogation response information to the second Internet of Things device to establish a connection relationship with the second Internet of Things device based on the device information.

The device information of the first Internet of Things device may include information such as a device identification of the first Internet of Things device and a system identification of the first Internet of Things system. The first Internet of Things device may generate interrogation response information carrying its device information to enable the second Internet of Things device to learn the response of the first Internet of Things device to its connection interrogation request.

In the present application, similar to the connection interrogation information, an interrogation response format can be set for interrogation response information in an application scenario in which device control is performed across the Internet of things systems Therefore, after receiving the connection interrogation information that is transmitted by the second Internet of Things device and meets the preset interrogation format, the first Internet of Things device may generate interrogation response information that meets the interrogation response format, and the interrogation response information may carry the device information of the first Internet of Things device.

There may be multiple manners in which the first Internet of Things device may transmit the interrogation response information to the second Internet of Things device. For example, the first Internet of Things device may reply to the second Internet of Things device via unicast.

Similar to the case that the first Internet of Things device may receive connection interrogation information from the plurality of second Internet of Things devices, each of the second Internet of Things device may further transmit connection interrogation information to a plurality of first Internet of Things devices, so that the second Internet of Things device may receive connection response information from the plurality of first Internet of Things devices. Since the connection response information includes the device information of the first Internet of Things devices, the second Internet of Things device may determine one of the first Internet of Things devices with which the second Internet of Things device decides to establish a connection relationship based on the connection response information.

As such, the first Internet of Things device and the second Internet of Things device can establish a preliminary connection consensus by means of the connection interrogation information and the connection response information and further establish a connection relationship between the first Internet of Things device and the second Internet of Things device. Further, the first Internet of Things device may receive the access information for the second cloud server transmitted by the second Internet of Things device based on the connection relationship. Specifically, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting and receiving access information for the second cloud server.

At step 102, device authentication information of the second cloud server may be obtained according to the access information.

The device authentication information of the second cloud server is related data required for the first Internet of Things device to authenticate the second cloud server. For example, the first Internet of Things device may verify the device authentication information to obtain a verification result of the device authentication information, and further determine the authentication result of the second cloud server according to the verification result.

There may be multiple manners of obtaining device authentication information of the second cloud server according to the access information. As an example, the access information transmitted by the second Internet of Things device to the first Internet of Things device can be used for the first Internet of Things device to access the second cloud server. Therefore, the first Internet of Things device can access the second cloud server through the received access information. As such, the first Internet of Things device can perform data interaction with the second cloud server. For example, the first Internet of Things device can obtain the device authentication information of the second cloud server.

In one embodiment, the access information obtained by the first Internet of Things device may include access address information and access parameter information of the second cloud server, where the access address information may be used for the first Internet of Things device to determine an access address of the second cloud server, so that the first Internet of Things device can access the second cloud server. The access parameter information may then be used for the second cloud server to verify the first Internet of Things device to determine whether the first Internet of Things device is allowed to access the second cloud server. As such, the first Internet of Things device can access the second cloud server based on the access address information and the access parameter information. For example, the first Internet of Things device can access the second cloud server by establishing a connection relationship between the first Internet of Things device and the second cloud server, and further obtain device authentication information of the second cloud server.

Specifically, the access information may include the access address information and the access parameter information, and the step of “obtaining device authentication information of the second cloud server according to the access information” can include:
establishing an access connection relationship with the second cloud server based on the access address information and the access parameter information; and
obtaining device authentication information of the second cloud server based on the access connection relationship.

The access address information is related information describing the access address of the second cloud server. Specifically, the first Internet of Things device may determine the access address of the second cloud server through the access address information, so as to further implement access to the second cloud server.

The access address information may be in a variety of forms; for example, the access address information may include physical address information, logical address information, port address information, specific address information, and the like; for another example, the access address information may be in the form of a uniform resource locator (URL); for another example, the access address information may be in the form of a two-dimensional code; and so on.

The access parameter information is related information describing the access parameter, where the access parameter may be used for the second cloud server to further process access requirements of the first Internet of Things device. For example, the access parameter may be an identity verification code of the first Internet of Things device. After receiving the access request of the first Internet of Things device, the second cloud server may further verify the identity of the first Internet of Things device based on the identity verification code to determine whether the first Internet of Things device is allowed to access the second cloud server. For another example, the access parameter may be a binding code of the first Internet of Things device that may be used for the second cloud server to bind the first Internet of Things device to a target user. Specifically, the target user here may be an associated user of the second Internet of Things device, for example, a user currently logged in to the second Internet of Things device.

Since the access address information of the second cloud server can enable the first Internet of Things device to determine the access address of the second cloud server to access the second cloud server and the access parameter information can further enable the second cloud server to process the access requirements of the first Internet of Things device, the first Internet of Things device can generate an access request based on the access address information and the access parameter information, and establish a connection relationship between the first Internet of Things device and the second Internet of Things device by transmitting an access request to the second cloud server. Specifically, the step of “establishing an access connection relationship with the second cloud server based on the access address information and the access parameter information” may include:
generating an access request based on the access address information and the access parameter information; and
transmitting the access request to the second cloud server to establish an access connection relationship with the second cloud server.

The access connection relationship is a connection relationship established when the second Internet of Things device accesses the second cloud server. Specifically, the access connection relationship between the second Internet of Things device and the second cloud server is established, that is, a connection channel for data interaction between the second Internet of Things device and the second cloud server can be established. As such, the second Internet of Things device and the second cloud server can perform data interaction through the connection channel, for example, transmitting and receiving device authentication information.

In some embodiments, the first Internet of Things device may determine the access address of the second cloud server based on the access address information, and further, the first Internet of Things device may generate an access request, where a destination address of the access request is access address of the second cloud server, and the access address may carry the access parameter information.

The first Internet of Things device may, after generating the access request, establish an access connection relationship with the second cloud server by transmitting an access request to the second cloud server.

As an example, the access address information may be a URL of the second cloud server, the access parameter information may be a binding code of the first Internet of Things device, and the first Internet of Things device may generate an access request based on the URL and the binding code, and establish an access connection relationship between the second Internet of Things device and the second cloud server by transmitting the access request to the second cloud server to connect the second cloud server.

As such, after the access connection relationship between the second Internet of Things device and the second cloud server is established, the second Internet of Things device can obtain device authentication information of the second cloud server based on the access connection relationship.

It should be noted in an actual application that the first Internet of Things device and the second cloud server may make a pre-agreement on the format of the access request, so that the second cloud server may, after receiving the access request, determine whether the access request is legal by determining whether the format of the access request matches the pre-agreement format. Further, if the access request is legal, the second cloud server may allow the first Internet of Things device to access the second cloud server, thereby establishing an access connection relationship between the first Internet of Things device and the second cloud server.

At step 103, the second cloud server may be authenticated based on the device authentication information.

In the present application, since there may be multiple manners in which the first Internet of Things device may authenticate the second cloud server, there may be multiple manners in which the first Internet of Things device may authenticate the second cloud server based on the device authentication information. For example, the first Internet of Things device may perform verification information of the device authentication information and determine the authentication result of the second cloud server based on the verification result of the device authentication information, thereby implementing authentication of the second cloud server.

For example, the first Internet of Things device may authenticate the second cloud server by means of certificate authentication, and then the device authentication information of the second cloud server obtained by the first Internet of Things device may be specifically a certificate of the second cloud server, so the first Internet of Things device may authenticate the second cloud server by verifying the certificate.

For another example, the first Internet of Things device may authenticate the second cloud server by means of key authentication, and then the device authentication information of the second cloud server obtained by the first Internet of Things device may be specifically a key of the second cloud server, so the first Internet of Things device may authenticate the second cloud server by verifying the key.

There may be multiple manners of verifying the device authentication information, for example, which may include comparing the device authentication information, calculating the device authentication information, querying and matching the device authentication information, and the like. In consideration of verifying the device authentication information, which is essentially the process of authenticating the second cloud server, it is possible to first determine related information required for authenticating the second cloud server, and further perform information verification for the device authentication information with the related information. Specifically, the step of “authenticating the second cloud server based on the device authentication information” may include:
determining authentication verification information required for verifying the second cloud server; and
performing information verification for the device authentication information with the authentication verification information to authenticate the second cloud server.

The authentication verification information is related information required for verifying the second cloud server and may be in various forms. For example, the authentication verification information may be a character string, a value, or a collection and the like.

There may be multiple manners in which the first Internet of Things device may determine authentication verification information required for authenticating the second cloud server; for example, the authentication verification information may be transmitted by the second Internet of Things device to the first Internet of Things device; for another example, the authentication verification information may be directly input into the first Internet of Things device by the user; for another example, the first Internet of Things device may obtain the authentication verification information through interaction between the terminal and the cloud; and so on.

In the present application, there may be multiple manners of performing information verification for the device authentication information, which may include, for example, information comparison, information calculation, interrogation and matching, and the like.

For example, performing information verification for the device authentication information may be implemented by performing information comparison on the device authentication information. Specifically, the first Internet of Things device may compare the authentication verification information required for authenticating the second cloud server with the device authentication information transmitted by the second cloud server to perform information verification for the device authentication information. Specifically, if the comparison result is consistent, it may be determined that the verification is passed. Otherwise, it is determined that the verification fails.

For another example, performing information verification for the device authentication information may be implemented by calculating the device authentication information. Therefore, the authentication verification information required for authenticating the second cloud server may be preset value information, such as a preset value or a value range. As an example, the authentication verification information may be a preset value range. After obtaining the device authentication information of the second cloud server, the first Internet of Things device may calculate the device authentication information, and compare the calculation result with the preset value range to perform information verification for the device authentication information. Specifically, if the calculation result falls within the preset value range, it may be determined that the verification is passed. Otherwise, it is determined that the verification fails.

For another example, performing information verification for the device authentication information may be implemented by querying and matching the device authentication information. Therefore, the authentication verification information required for verifying the second cloud server may be a preset information set, and at least one information element may be included in the set. For example, the set may include at least one piece of device verification information authenticated by the first Internet of Things device. After obtaining the device authentication information of the second cloud server, the first Internet of Things device may verify the device authentication information by interrogating whether there is an information element matching the device authentication information in the information set. Specifically, if there is an information element matching the device authentication information in the information set, the first Internet of Things device may determine that the verification is passed. Otherwise, it is determined that the verification fails.

At step 104, in response to the authentication being passed, authority information of the second Internet of Things device for the first Internet of Things device may be set.

The authority information of the second Internet of Things device for the first Internet of Things device is related information describing a device control authority of the second Internet of Things device to the first Internet of Things device.

As an example, the device control authority of the second Internet of Things device to the first Internet of Things device may include a service calling authority, an information changing authority, and the like. For example, the service calling authority may be a call authority of the second Internet of Things device for a service provided by the first Internet of Things device, and the information changing authority may be a changing authority of the second Internet of Things device for device control information stored in the first Internet of Things device.

There may be multiple manners of setting the device control authority of the second Internet of Things device for the first Internet of Things device. For example, related data of maintaining the device control authority in the first Internet of Things device may be modified, so that the first Internet of Things device may set the device control authority of the second Internet of Things device for the first Internet of Things device according to the modified related data. As an example, the setting of the device control authority of the second Internet of Things device for the first Internet of Things device may be implemented by setting Access Control Lists (ACL) of the first Internet of Things device based on the device control information.

The ACL is an access control technology based on packet filtering, which can filter packets on an interface according to a set condition, and allow the packets to pass or be discarded. The access control lists are widely applied to routers and layer-3 switches, and access of a user to a network can be effectively controlled by means of the access control lists, thereby ensuring network security to the maximum extent.

In some embodiments, it is considered that the second Internet of Things device can need to learn the device capability of the first Internet of Things device before further setting the device control information of the second Internet of Things device to the first Internet of Things device, that is, the first Internet of Things device can need to enable the second Internet of Things device to learn the device capability information of the first Internet of Things device before further setting the device control information of the second Internet of Things device to the first Internet of Things device.

There may be multiple manners in which the second Internet of Things device learns a device capability of the first Internet of Things device; for example, the device capability may be actively transmitted from the first Internet of Things device to the second Internet of Things device; for another example, after the second Internet of Things device can request the device capability of the first Internet of Things device from the first Internet of Things device, the first Internet of Things device transmits the device capability of the first Internet of Things device to the second Internet of Things device; and so on.

In some embodiments, after the first Internet of Things device has authenticated the second cloud server, the first Internet of Things device may enable the second Internet of Things device to learn the device capability of the first Internet of Things device, so that the authority information of the second Internet of Things device for the first Internet of Things device may be further set. Specifically, the step of “in response to the authentication being passed, setting the authority information of the second Internet of Things device for the first Internet of Things device” may include:
if the authentication is passed, transmitting device capability information of the first Internet of Things device to the second Internet of Things device in response to a device capability request transmitted by the second Internet of Things device, where the device capability information is configured to instruct the second Internet of Things device to generate device control information for the first Internet of Things device; and
receiving device control information transmitted by the second Internet of Things device to set authority information of the second Internet of Things device for the first Internet of Things device based on the device control information.

The device capability request is data for requesting to obtain a capability model of the first Internet of Things device. Data formats of the device capability request may include a variety of data formats, for example, packet data, such as a multicast packet, a broadcast packet, or the like.

The device capability information of the first Internet of Things device is related information describing the device capability that can be provided by the first Internet of Things device. For example, the device capability information may include a specific model, a type, a controllable instruction, an attribute, a service, and the like of the device. It should be noted in a practical application that the device capability information of the first Internet of Things device may also be referred to as a capability model of the first Internet of Things device.

The device control information of the second Internet of Things device is related information indicating that the first Internet of Things device sets a control authority, and the control authority is a device control authority of the second Internet of Things device for the first Internet of Things device.

There may be multiple manners in which the first Internet of Things device may transmit the device capability information of the first Internet of Things device to the second Internet of Things device in response to the device capability request transmitted by the second Internet of Things device. Specifically, the first Internet of Things device may obtain the device capability request transmitted by the second Internet of Things device, so that the first Internet of Things device may further transmit the device capability information of the first Internet of Things device to the second Internet of Things device in response to the device capability request. For example, the second Internet of Things device may transmit a device capability request to the first Internet of Things device; for another example, the second Internet of Things device may have a paired second pairing server (e.g., the second pairing server may be a server of the same Internet of Things system to which the second Internet of Things device belongs; for another example, the second pairing server may be a server with authorization of the second Internet of Things device; the like), the second Internet of Things device may transmit a device capability request to the second pairing server to transmit the device capability request to the first Internet of Things device through the second pairing server; and so on. Specifically, the step of “in response to the device capability request transmitted by the second Internet of Things device, transmitting the device capability information of the first Internet of Things device to the second Internet of Things device” may include:
receiving device capability request transmitted by the second Internet of Things device; and
in response to the device capability request, transmitting device capability information of the first Internet of Things device to the second Internet of Things device.

In some embodiments, in order to ensure the security of the data interaction, the first Internet of Things device and the second Internet of Things device may make an agreement on a format of the device capability request, so that the second Internet of Things device may request to obtain a capability model of the first Internet of Things device by generating a device capability request meeting a preset agreement format and transmitting the device capability request to the first Internet of Things device. Correspondingly, the first Internet of Things device can receive the device capability request transmitted by the second Internet of Things device.

Further, the first Internet of Things device can, in response to the device capability request, transmit device capability information of the first Internet of Things device to the second Internet of Things device.

In some embodiments, it is considered that the first Internet of Things device needs to first determine the device capability information of the first Internet of Things device and then transmit the device capability information to the second Internet of Things device, so that the second Internet of Things device can further generate device control information for the first Internet of Things device. Therefore, the step of “in response to the device capability request, transmitting the device capability information of the first Internet of Things device to the second Internet of Things device” may include:
determining device capability information of the first Internet of Things device; and
in response to the device capability request, transmitting device capability information of the first Internet of Things device to the second Internet of Things device.

It should be noted in the present application that there may be multiple manners of triggering the first Internet of Things device to determine its device capability information; for example, a device capability request transmitted by the second Internet of Things device can trigger the first Internet of Things device to determine its device capability; for another example, the first Internet of Things device may store data related to its device capability information, and the first Internet of Things device may periodically maintain the data, for example, periodically perform a data query, and update the data when a change of the data is detected, thereby determining the device capability information of the first Internet of Things device; for another example, the first Internet of Things device may obtain device capability information of the first Internet of Things device by requesting a cloud; and so on.

After determining device capability information of the first Internet of Things device, the first Internet of Things device can, in response to the device capability request transmitted by the second Internet of Things device, transmit device capability information of the first Internet of Things device to the second Internet of Things device. For example, the device capability information may be transmitted to the second Internet of Things device in the form of a packet. For another example, the device capability information may be transmitted to the second Internet of Things device by interaction with the cloud. Alternatively, the first Internet of Things device and the second Internet of Things device may make a pre-agreement on a format for transmitting and receiving the device capability information.

Since the device capability information transmitted by the first Internet of Things device to the second Internet of Things device may be used to instruct the second Internet of Things device to generate device control information for the first Internet of Things device, the first Internet of Things device may correspondingly receive the device control information transmitted by the second Internet of Things device.

In the present application, there may be multiple manners in which the first Internet of Things device obtains the device authentication information of the second Internet of Things device. For example, the first Internet of Things device may receive the device control packet transmitted by the second Internet of Things device to extract the device control information of the second Internet of Things device from the device control packet. Specifically, the step of “obtaining the device control information of the second Internet of Things device” may include:
receiving device control packet transmitted by the second Internet of Things device; and
extracting device control information of the second Internet of things device from the device control packet.

The device control packet is packet data for transmitting the device control information.

In some embodiments, the second Internet of things device may transmit a device control packet to the first Internet of things device in a predetermined format, where the device control packet may include device control information of the second Internet of things device. Correspondingly, the first Internet of Things device may receive a device control packet transmitted by the second Internet of Things device, and extract the device control information of the second Internet of Things device from the device control packet. For example, the third party local hub may transmit a device control packet request to the IoT device in a predetermined format to request an Access Control Lists (ACL) to the IoT device. Correspondingly, the IoT device may receive the device control packet and extract device control information from the device control packet to set the ACL of the IoT device based on the device control information.

As an example, the first Internet of Things device may receive the device control packet transmitted by the second Internet of Things device through the connection relationship established in the configuration process. Specifically, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting device control packet and receiving the device control packet.

Further, the first Internet of Things device may set authority information of the second Internet of Things device for the first Internet of Things device based on the received device control information.

In some embodiments, considering that the second Internet of Things device and the first Internet of Things device belong to different Internet of Things systems, device control of the second Internet of Things device to the first Internet of Things device is essentially a device control performed across the Internet of Things systems. The device control object may implement device control of the first Internet of Things device via the second Internet of Things device. Therefore, the setting of the device control authority of the second Internet of Things device for the first Internet of Things device can be implemented by setting a device control authority of a device control object in a second Internet of Things system for the first Internet of Things device.

Specifically, the device control information includes a system identification of a target Internet of Things system and an object identification of a device control object, where the target Internet of Things system is an Internet of Things system to which the second Internet of Things device belongs, i.e., the second Internet of Things system, and the device control object is an object that controls a first Internet of Things device via the second Internet of Things device. Specifically, the step of “setting a device control authority of the second Internet of Things device for the first Internet of Things device based on the device control information” can include:
setting a device control authority of the device control object in the target Internet of Things system for the first Internet of Things device based on the system identification and the object identification.

The system identification is identification information for uniquely identifying the Internet of things system, and the system identification may be in a variety of forms, for example, may include different data forms such as a character string, an image, and an audio. In a practical application, the system identification of the target Internet of things system may be referred to as an ecological identification code of the target Internet of things system, which may be used to uniquely identify a third party manufacturer. For example, if the second Internet of Things device may be a third party local hub, correspondingly the system identification of the Internet of Things system to which the second Internet of Things device belongs is an ecological identification code of the third party local hub.

The object identification is identification information for uniquely identifying a device control object in the Internet of things system, and the object identification may be in a variety of forms, for example, may include different data forms such as a character string, an image, and an audio. The device control object is an object for controlling the first Internet of Things device. For example, the device control object may be a user, an Internet of Things device or the like. In a practical application, the object identification of the device control object may be referred to as a subject Identity Document (ID), where the subject ID may be used to uniquely identify a user or an Internet of Things device within a third party manufacturer (the Internet of Things device may act as a controller in an application scenario of device control) and may be unique within the third party manufacturer.

In a practical application, the second Internet of Things device may allocate different object identification to different device control objects in the target Internet of Things system. For example, the third party local hub may allocate different subject IDs to different controllers, users, etc., within its own ecology.

After determining the system identification of the target Internet of Things system and the object identification of the device control object, the first Internet of Things device may further set the device control authority of the device control object in the target Internet of Things system for the first Internet of Things device based on the system identification and the object identification.

As an example, if the system identification is an identification a corresponding to a manufacturer A and the object identification is an identification b corresponding to a user B in the device control information received by the first Internet of Things device, the first Internet of Things device may modify the ACL of the first Internet of Things device based on the identification a and the identification b. As such, the user B may set the device control authority of the first Internet of Things device. It should be noted that the device control authority provided here is a control authority for the first Internet of Things device owned by the user B in the Internet of things system corresponding to the manufacturer A.

As another example, if the system identification is an identification a corresponding to a manufacturer C and the object identification is an identification b corresponding to a user B in the device control information received by the first Internet of Things device, the first Internet of Things device may set a device control authority of the user B for the first Internet of Things device similarly. It should be noted that the device control authority provided here is a control authority for the first Internet of Things device owned by the user B in the Internet of things system corresponding to the manufacturer C.

As another example, if the system identification is an identification a corresponding to a manufacturer A and the object identification is an identification b corresponding to a controller D in the device control information received by the first Internet of Things device, the first Internet of Things device may set a device control authority of the controller D for the first Internet of Things device similarly. It should be noted that the control authority provided here is a control authority for the first Internet of Things device owned by the controller D in the Internet of things system corresponding to the manufacturer A.

In some embodiments, considering that, in an application scenario in which device control is performed across the Internet of things systems, a different authority may be allocated to each of device control objects in the target Internet of things system, and the authority may be embodied by an object attribute of the device control object. Therefore, the device control information obtained by the first Internet of things device may further include object attribute information of the device control object. Specifically, the step of “setting a device control authority of the device control object in the target Internet of Things system for the first Internet of things device based on the system identification and the object identification” can include:
determining a service calling authority of the device control object for the first Internet of Things device based on the object attribute information, where the service calling authority is a calling authority of the device control object for a service provided by the first Internet of Things device, and the service provided by the first Internet of Things device is determined based on the device capability information of the first Internet of Things device; and
setting a device control authority of the device control object in the target Internet of Things system for the first Internet of Things device based on the service calling authority.

The object attribute information is used to describe object attributes of the device control object, different object attributes represent different roles, and different roles represent different authority. For example, the authorities may include a service calling authority and an information changing authority. In the present application, each of the object identification of the device control object corresponds to one of the object attributes of the device control object, respectively. That is, in a practical application, each of the roles of the device control object corresponds to one of the subject IDs, respectively.

For example, if the object attribute of the device control object is role 1, it indicates that the device control object has only the service calling authority on the first Internet of Things device, and if the object attribute of the device control object is role 2, it indicates that the device control object has the service calling authority and the information changing authority for the first Internet of Things device. For another example, if the object attribute of the device control object is role 1, it indicates that the device control object has only the service calling authority for the first Internet of Things device; if the object attribute of the device control object is role 2, it indicates that the device control object has the information changing authority for the first Internet of Things device; and if the object attribute of the device control object is role 3, it indicates that the device control object has the service calling authority and the information changing authority for the first Internet of Things device; and so on.

In some embodiments, the object attribute of the device control object may include an administrator and an ordinary user. Specifically, if the object attribute of the device control object is the administrator, the device control object may have an information changing authority and a service calling authority for the first Internet of Things device; and if the object attribute of the device control object is the ordinary user, the device control object may have only the service calling authority on the first Internet of Things device.

The information changing authority represents a changing authority of the device control object for the device control information stored by the first Internet of Things device. For example, the information changing authority represents a changing authority of the device control object for the ACL of the first Internet of Things device.

The service calling authority is a calling authority of the device control object for a service provided by the first Internet of Things device, and the service provided by the first Internet of Things device is determined based on the device capability information of the first Internet of Things device. If the device control object has a service calling authority for the first Internet of Things device, the device control object can call a service authorized in the first Internet of Things device. For example, the first Internet of Things device may be an intelligent air conditioner, the service provided by the first Internet of Things device may include a refrigeration service, a dehumidification service, a heating service, and the like. If the device control object has a service calling authority for the intelligent refrigerator, the device control object can call a service authorized in the intelligent refrigerator.

Therefore, the first Internet of Things device may determine whether the device control object has a service calling authority for the first Internet of Things device based on the object attribute information of the device control object, so that the first Internet of Things device may further set a device control authority of the device control object in the target Internet of Things system for the first Internet of Things device.

As an example, if the first Internet of Things device may be an intelligent television, the device control object of the second Internet of Things device may be a child E, and the object attribute of the child E is an ordinary user, then, the intelligent television may determine that the child E has the service calling authority for the intelligent television based on the object attribute information of the child E, and set the device control authority of the child E in the target Internet of Things system for the intelligent television, including the service calling authority for the intelligent television.

In another embodiment, the device control information may further include service accessing information of the device control object, where the service accessing information includes an authorized access service of the device control object to the first Internet of Things device, and an access authority of the device control object for the authorized access service. Therefore, the first Internet of Things device may determine the service accessing authority of the device control object for the first Internet of Things device based on the service accessing information after determining that the device control object has the service calling authority for the first Internet of Things device, so as to further determine the service calling authority of the device control object for the first Internet of Things device. Specifically, the step of “determining a service calling authority of the device control object for the first Internet of Things device” can include:
determining a service accessing authority of the device control object for the first Internet of Things device based on the service accessing information.

As an example, the first Internet of Things device may be an intelligent television, the device control object of the second Internet of Things device may be a child E, the object attribute of the child E is an ordinary user, the service accessing information of the child E includes an authorized access service of the child E to the intelligent television and an access authority of the child E for the authorized access service. Specifically, the authorized access service of the child E to the intelligent television includes following two services: viewing a science and education channel, and viewing an animation channel, and the access authority of the child E for the “viewing a science and education channel” is two hours per day, and the access authority of the child E for the “viewing an animation channel” is one hour per day. Then, the intelligent television may determine the service accessing authority of the child E for the intelligent television based on the authorized access service of the child E and the access authority of the child E for the authorized access service, so as to further determine what service in the intelligent television the child E can specifically access and the specific authority of the child E for the accessible service on the basis of determining that the child E has the service calling authority for the intelligent television.

In another embodiment, if the object attribute information of the device control object indicates that the device control object further has the information changing authority for the first Internet of Things device, the target controlled device may correspondingly set the device control authority of the device control object for the first Internet of Things device. Specifically, the step of “setting the device control authority of the device control object in the target Internet of Things system for the first Internet of Things device based on the service call authority” can include:
if the object attribute information indicates that the device control object has an information changing authority for the first Internet of Things device, setting a device control authority of the device control object in the target Internet of Things system for the first Internet of Things device based on the information changing authority and the service calling authority, where the information changing authority represents a changing authority of the device control object for the device control information stored in the first Internet of Things device.

As an example, if the first Internet of Things device may be an intelligent television, the device control object of the second Internet of Things device may be an adult F, and the object attribute of the adult F is an administrator, then, the intelligent television may determine that the adult F has the service calling authority and information changing authority for the intelligent television based on the object attribute information of the adult F, and set the device control authority of the adult F in the target Internet of Things system for the intelligent television, including the service calling authority and information changing authority for the intelligent television.

In a practical application, the device control information received by the first Internet of Things device may further include information such as a device ID, a connection key, and a key expiration time of the connection key, in addition to a system identification of an Internet of Things system to which the second Internet of Things device belongs, object identification of the device control object, object attribute information, and service accessing information.

The device ID is further referred to as a target device identification, which is a unique ID assigned by the target Internet of Things system for the first Internet of Things device and can be used to uniquely identify a device in the target Internet of Things system. The connection key may be used by the first Internet of Things device to establish a control connection with the second Internet of Things device, and each of the connection keys corresponds to one of the object identifications, respectively.

In a practical application, the second Internet of Things device may allocate information such as different object identification, keys, object attributes and the like to different device control objects in the target Internet of Things system. For example, the third party local hub may allocate information such as different subject Ids, keys, roles, and the like to different controllers, users, etc., within its own ecology.

The process of setting the device control authority is described above from the perspective of the first Internet of Things device. In a practical application, the device control may be further performed on the basis of the foregoing process. Specifically, the method for setting the device control authority may further include:
receiving a device control instruction transmitted by the second Internet of Things device, where the device control instruction is used by the second Internet of Things device to perform device control for the first Internet of Things device; and
executing an operation corresponding to the device control instruction.

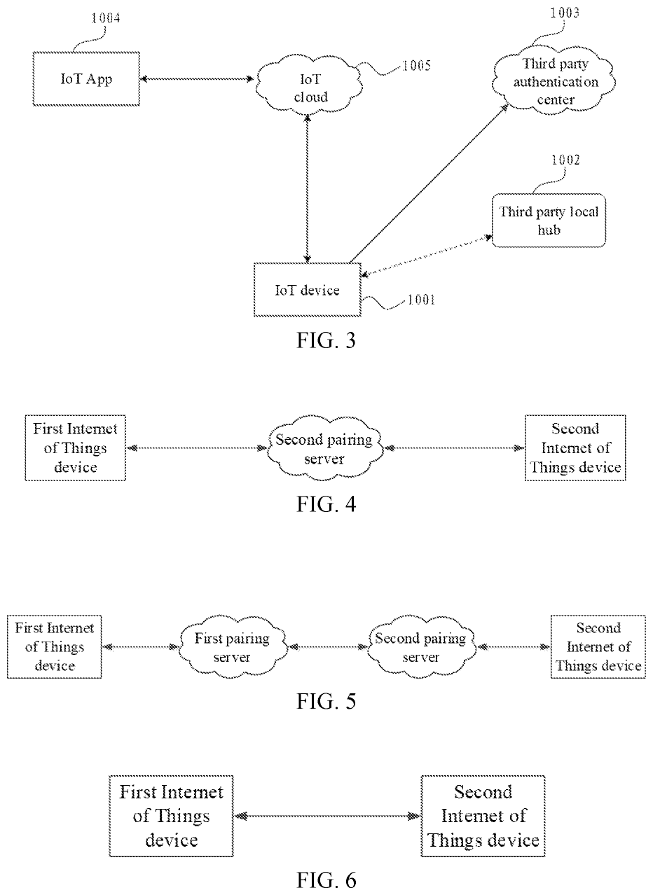

In the present application, there may be multiple manners in which the first Internet of Things device receives the device control instruction transmitted by the second Internet of Things device. For example, in some embodiments, referring to FIG. 4, the second Internet of Things device may transmit the device control instruction to a second pairing server paired with the second Internet of Things device, and further the second pairing server may transmit the device control instruction to the first Internet of Things device so that the first Internet of Things device may receive the device control instruction transmitted by the second Internet of Things device. Specifically, the step of “receiving the device control instruction transmitted by the second Internet of Things device” may include:
receiving a device control instruction transmitted by a second pairing server paired with the second Internet of Things device, where the device control instruction is an instruction transmitted by the second Internet of Things device to the second pairing server.

It should be noted that the second pairing server paired with the second Internet of Things device may be a cloud server of the same Internet of Things system as the second Internet of Things device.

In another embodiment, referring to FIG. 5, the second Internet of Things device may transmit a device control instruction to a second pairing server paired with the second Internet of Things device, and the second pairing server may transmit the device control instruction to a first pairing server paired with the first Internet of Things device. Further, the first pairing server may transmit the device control instruction to the first Internet of Things device, so that the first Internet of Things device may receive the device control instruction transmitted by the second Internet of Things device. Specifically, the step of “receiving the device control instruction transmitted by the second Internet of Things device” may include:
receiving a device control instruction transmitted by a first pairing server paired with the first Internet of Things device, where the device control instruction is an instruction transmitted by the second Internet of Things device to the first pairing server via a second pairing server, and the second pairing server is a cloud server paired with the second Internet of Things device.

Similarly, the first pairing server paired with the first Internet of Things device may be a cloud server of the same Internet of Things system to which the first Internet of Things device belongs.

In another alternative embodiment, referring to FIG. 6, the first Internet of Things device may establish a control connection relationship with the second Internet of Things device, so that a device control instruction transmitted by the second Internet of Things device may be received based on the control connection relationship. Specifically, the step of “receiving a device control instruction transmitted by the second Internet of Things device” can include:
establishing a control connection relationship with the second Internet of Things device, wherein the control connection relationship is configured for the second Internet of Things device to perform device control for the first Internet of Things device; and
receiving a device control instruction transmitted by the second Internet of Things device based on the control connection relationship.

It should be noted that the control connection relationship established here is a connection relationship in a control process. Specifically, a process in which the second Internet of Things device performs device control for the first Internet of Things device may include both configuration and control. The control refers to a process in which the second Internet of Things device performs device control for the first Internet of Things device. For example, the second Internet of Things device may control the first Internet of Things device by transmitting a device control instruction to the first Internet of Things device.

In the present application, the control may be directly performed after the configuration is completed. If the connection relationship established in the configuration process is valid, the first Internet of Things device may continue using the connection relationship established in the configuration process, and receive a device control instruction transmitted by the second Internet of Things device based on the connection relationship.

If the connection relationship is invalid, or the second Internet of Things device does not directly control the first Internet of Things device after the configuration is completed, but controls the first Internet of Things device after the configuration is completed and the connection relationship is invalid, the first Internet of Things device may establish a control connection relationship with the second Internet of Things device so that the device control instruction transmitted by the second Internet of Things device may be received based on the control connection relationship.

There are multiple manners in which the first Internet of Things device may establish the control connection relationship with the second Internet of Things device. For example, since the device control information of the second Internet of Things device obtained by the first Internet of Things device may include an object identification of the device control object and connection key information corresponding to the device control object, the control connection relationship with the second Internet of Things device may be established based on the object identification and the connection key information. Specifically, the step of “establishing the control connection relationship with the second Internet of Things device” can include:
establishing a control connection relationship with the second Internet of Things device based on the object identification and the connection key information.

For example, the first Internet of Things device and the second Internet of Things device may perform security negotiation with the objection identification and the connection key information to establish an encrypted connection, so as to establish a control connection relationship between the first Internet of Things device and the second Internet of Things device. It should be noted that the method for establishing the control connection relationship herein may be the same as or different from the method for establishing the connection relationship in the configuration process in the foregoing description, which is not limited in the present application.

In some embodiments, since there may be a plurality of second Internet of Things devices in different Internet of things systems that have set their device control authorities for the first Internet of Things device in consideration of a practical application, and there may be a plurality of second Internet of Things devices requesting to establish the control connection relationship with the first Internet of Things device in the control process and the first Internet of Things device should establish the control connection relationship with the configured second Internet of Things devices, the first Internet of Things device may determine a target second Internet of Things device from the plurality of second Internet of Things devices and establish the control connection relationship with the target second Internet of Things device. Specifically, the device control information of the second Internet of Things device obtained by the first Internet of Things device may further include a system identification of an Internet of Things system to which the second Internet of Things device belongs, i.e., a target system identification of the target Internet of Things system, and a target device identification allocated by the target Internet of Things system for the first Internet of Things device in addition to the object identification of the device control object and the connection key information corresponding to the device control object. Specifically, the step of “establishing a control connection relationship with the second Internet of Things device based on the object identification and the connection key information” can include:
obtaining a control connection request of a second Internet of Things device, wherein the control connection request includes a second system identification, and the second system identification is a device identification of an Internet of things system to which the second Internet of Things device belongs; and
in response to the second system identification matching the target system identification, establishing a control connection relationship with the second Internet of Things device based on the target device identification, the object identification, and the connection key information.

The control connection request obtained by the first Internet of Things device is data requesting to establish a control connection relationship with the first Internet of Things device. The control connection request may include a second system identification, where the second system identification is a system identification of the Internet of things system to which the second Internet of Things device transmitting the control connection request belongs. Data forms of the control connection request may include a variety of data forms, such as a multicast packet, a broadcast packet.

In the control process, the first Internet of Things device may obtain a plurality of control connection requests, which may be transmitted by the second Internet of Things devices of the different Internet of things systems to the first Internet of Things device. The first Internet of Things device may compare a second system identification corresponding to each of the control connection requests with the target system identification, and if the second system identification matches the target system identification, it may be determined that the second Internet of Things device transmitting the control connection request is the configured second Internet of Things device along with the first Internet of Things device, and the first Internet of Things device may further establish a control connection relationship with the second Internet of Things device based on the target device identification, the object identification, and the connection key information.

As an example, the second Internet of Things device may transmit a multicast or broadcast packet by means of a multicast packet or the like within a local area network, so as to transmit a control connection request to the first Internet of Things device, where the control connection request includes a second system identification being a device identification of an Internet of things system to which the second Internet of Things device belongs, and a format of the packet is agreed in advance. Accordingly, the first Internet of Things device can obtain the control connection request of the second Internet of Things device. If the second system identification matches the target system identification, the first Internet of Things device may further establish a control connection relationship with the second Internet of Things device based on the target device identification, the object identification, and the connection key information. Specifically, the step of “establishing a control connection relationship with the second Internet of Things device based on the target device identification, the object identification, and the connection key information” may include:
generating device connection response information of the device connection request, where the device connection response information comprises the target device identification; and
transmitting the device connection response information to the second Internet of Things device to establish the control connection relationship with the second Internet of Things device based on the object identification and the connection key information.

As an example, after obtaining the control connection request of the second Internet of Things device, the first Internet of Things device may determine the Internet of things system to which the second Internet of Things device transmitting the control connection request belongs based on the second system identification included in the control connection request, and the first Internet of Things device may determine the device ID allocated by the Internet of things system for the first Internet of Things device, and generate device connection response information including the device ID.

Further, the first Internet of Things device may transmit the device connection response information to the second Internet of Things device, so that the second Internet of Things device learns identity of the first Internet of Things device with which the second Internet of Things device establishes a control connection relationship. As such, the first Internet of Things device may further establish the control connection relationship with the second Internet of Things device based on the object identification and the connection key information.

After the connection relationship between the first Internet of Things device and the second Internet of Things device is established, the first Internet of Things device can receive the device control instruction transmitted by the second Internet of Things device based on the control connection relationship. As an example, after the connection relationship between the first Internet of Things device and the second Internet of Things device is established, i.e., a control connection channel for data interaction between the first Internet of Things device and the second Internet of Things device may be established, the first Internet of Things device and the second Internet of Things device may perform data interaction via the control connection channel, for example, transmitting device control instruction and receiving the device control instruction.

In the present application, after receiving the device control instruction transmitted by the second Internet of Things device, the first Internet of Things device may perform an operation corresponding to the device control instruction.

For example, the device control instruction may include a service calling instruction, where the service calling instruction may be used to call a service provided by the first Internet of Things device. Thus, the first Internet of Things device may receive the service calling instruction transmitted by the second Internet of Things device and call a service corresponding to the service calling instruction to implement device control of the second Internet of Things device to the first Internet of Things device.

For another example, the device control instruction may include an information changing instruction, where the information changing instruction may be used to change device control information stored by the first Internet of Things device. For example, the information changing instruction may be used to modify the ACL of the first Internet of Things device, for example, may be used to modify authority information stored in the ACL, and may be used to update connection key information stored in the ACL, or the like. Specifically, the step of “executing an operation corresponding to the device control instruction” can include:
determining a device control object corresponding to the device control instruction; and
in response to the device control object having an information changing authority for the first Internet of Things device, executing an information changing operation corresponding to the information changing instruction.

There may be a plurality of manners in which the first Internet of Things device determines the device control object corresponding to the device control instruction. For example, the first Internet of Things device may receive the device control request transmitted by the second Internet of Things device, where the device control request may include the device control instruction and the object identification of the device control object, so that the first Internet of Things device may determine the device control object corresponding to the device control instruction based on the object identification.

Further, the first Internet of Things device may determine whether the device control object has an information changing authority, for example, by interrogating the device control information stored by the first Internet of Things device, such as, by interrogating the ACL of the first Internet of Things device. Specifically, if the device control object has an information changing authority for the first Internet of Things device, the first Internet of Things device executes an information changing operation corresponding to the information changing instruction.

As an example, the device control object of the second Internet of Things device may be a third party local hub F whose an object attribute is an administrator. That is, the third party local hub F has the information changing authority for the first Internet of Things device. In this example, the third party local hub F may periodically transmit a device control instruction to the first Internet of Things device, where the device control instruction may include an ACL packet and an object identification of the third party local hub F, and the ACL packet is used for the first Internet of Things device to update its ACL.

After receiving the device control instruction, the first Internet of Things device may extract the object identification from the device control instruction, and may interrogate the ACL to know that the device control object corresponding to the device control instruction is the third party local hub F, and the object attribute of the third party local hub F is the administrator. Therefore, the first Internet of Things device may determine that the third party local hub F has the information changing authority for the first Internet of Things device, and in this case, the first Internet of Things device may perform the information changing operation corresponding to the information changing instruction based on the ACL packet, that is, update the ACL.

As can be seen from above that the present embodiments can receive access information for a second cloud server transmitted by a second Internet of Things device that has established a connection relationship with the first Internet of Things device, where the first Internet of Things device and the second Internet of Things device belong to different Internet of Things systems, and the second cloud server is a cloud server having a trust relationship with the second Internet of Things device; obtain device authentication information of the second cloud server according to the access information; authenticate the second cloud server based on the device authentication information; and in response to the authentication being passed, set authority information of the second Internet of Things device for the first Internet of Things device.

The solution can enable the second Internet of Things device that belongs to the different Internet of Things system than the first Internet of Things device to set the device control authority for the first Internet of Things device, thereby implementing device control in a scenario across the Internet of Things systems. In addition, the solution can, before setting the device control authority of the second Internet of Things device for the first Internet of Things device, authenticate the second Internet of Things device by interacting with a cloud server trusted by the second Internet of Things device, which not only enhances the security of device control, but also reduces the cost requirement for the second Internet of Things device. For example, the second Internet of Things device does not need to use a security chip, or prepares a certificate key locally. Therefore, device control across the Internet of Things systems can be efficiently and securely realized.

In addition, compared with the protocol interconnection or standardization between one cloud and another cloud or between an end and one cloud, the solution avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the solution can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

In accordance with the methods described in the above embodiments, further details are given below by way of example.

The present embodiment will be described from the perspective of a second setting apparatus, which may be specifically integrated in a terminal. For example, the second setting apparatus may be integrated in the second Internet of Things device.

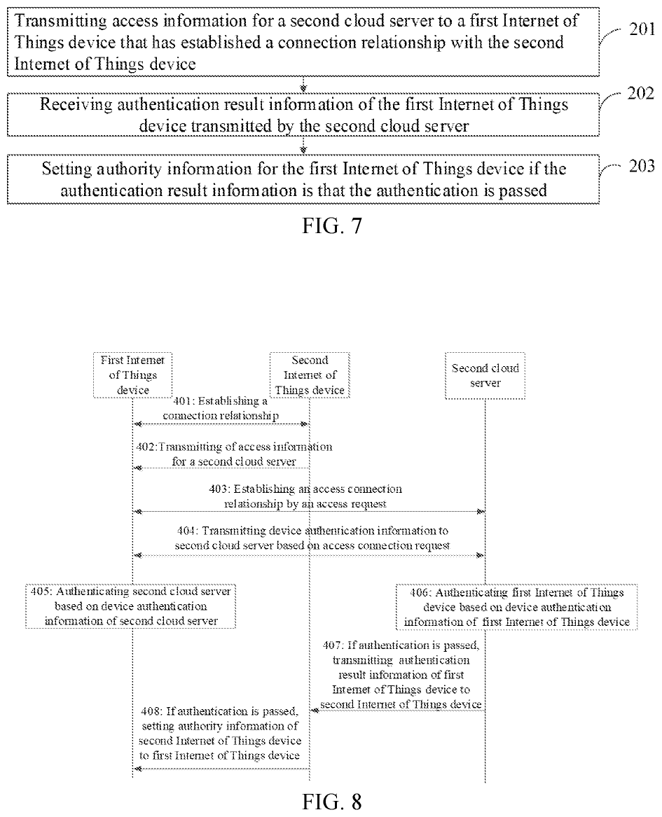

As shown in FIG. 7, a method for setting a device control authority includes steps 201-203 as follows.

At step 201, access information for the second cloud server may be transmitted to the first Internet of Things device that has established a connection relationship with the second Internet of Things device, where the access information is configured to establish an access connection relationship between the first Internet of Things device and the second cloud server, the access connection relationship is configured for the second cloud server to authenticate the first Internet of Things device, the second cloud server is a cloud server having a trust relationship with the second Internet of Things device, and the second Internet of Things device 20 and the first Internet of Things device belong to different Internet of Things systems.

There may be multiple manners in which the second Internet of Things device may transmit access information of the second cloud server. For example, transmission of the information may be implemented through interaction between the terminal and the server. For another example, the connection relationship between the second Internet of Things device and the first Internet of Things device may be established, and the access information for the second cloud server is transmitted to the first Internet of Things device based on the connection relationship. Specifically, the step of “transmitting the access information for the second cloud server to the first Internet of Things device that has established the connection relationship with the second Internet of Things device” may include:
establishing a connection relationship between the second Internet of Things device and the first Internet of Things device; and
transmitting the access information for the second cloud server to the first Internet of Things device based on the connection relationship.

In some embodiments, the second Internet of Things device may request the first Internet of Things device to establish a connection relationship between the second Internet of Things device and the first Internet of Things device by transmitting connection interrogation information to the first Internet of Things device. Specifically, the step of “establishing a connection relationship between the second Internet of Things device and the first Internet of Things device” can include:
generating connection interrogation information meeting a preset interrogation format;
transmitting the connection interrogation information to the first Internet of Things device to receive interrogation response information transmitted by the first Internet of Things device based on the connection interrogation information, where the interrogation response information includes device information of the first Internet of Things device; and
establishing a connection relationship between the second Internet of Things device and the first Internet of Things device based on the device information.

As an example, the second Internet of Things device may generate connection interrogation information, which may be specifically in the form of a packet being a pre-agreed preset interrogation format. The second Internet of Things device may transmit a multicast packet or a broadcast packet in the local area network by means of the multicast packet or the like, so as to transmit the connection interrogation information to the first Internet of Things device.

Further, the second Internet of Things device may receive interrogation response information transmitted by the first Internet of Things device based on the connection interrogation information, where the interrogation response information may be specifically in the form of a packet being a pre-agreed interrogation response format, and the interrogation response information includes device information of the first Internet of Things device.

In a practical application, it is considered that the second Internet of Things device may establish a connection relationship with a plurality of first Internet of Things devices and thus control the first Internet of Things devices, that is, the second Internet of Things device may transmit connection interrogation information to the plurality of first Internet of Things devices, and accordingly, the second Internet of Things device may receive interrogation response information returned by the plurality of first Internet of Things devices. Therefore, the second Internet of Things device may determine the identity of respective one of the first Internet of Things devices with which the second Internet of Things device will establish a connection relationship based on the device information in the interrogation response information received by the second Internet of Things device.

After determining the identity of the first Internet of Things device with which the second Internet of Things device will establish a connection relationship, the second Internet of Things device can establish a connection relationship with the first Internet of Things device. There may be a number of ways of establishing the connection relationship between the first Internet of Things device and the second Internet of Things device. For example, the connection relationship can be implemented by exchanging a key, for example, by exchanging a Personal Identification Number (PIN) code. Specifically, the step of “establishing the connection relationship between the second Internet of Things device and the first Internet of Things device based on the device information” can include:
obtaining connection verification information of the first Internet of Things device based on the device information; and
establishing a connection relationship between the second Internet of Things device and the first Internet of Things device based on the connection verification information.

The connection verification information is related information to be verified upon establishing the connection relationship between the second Internet of Things device and the first Internet of Things device in the configuration process. Specifically, if verification of the connection verification information is passed, the connection relationship between the second Internet of Things device and the first Internet of Things device can be further established. Otherwise, the connection relationship between the hub node and the target controlled device is not established. For example, the connection verification information may be key information, such as a PIN code.

There may be multiple manners in which the second Internet of Things device may obtain the connection verification information of the first Internet of Things device based on the device information of the first Internet of Things device. For example, the connection verification information may be input by a user. Specifically, the second Internet of Things device may, after obtaining the device information of the first Internet of Things device, prompt the user that the first Internet of Things device is to be networked with the second Internet of Things device and thus require the user to perform out-of-band confirmation by inputting a PIN code or scanning a two-dimensional code, or the like.

In some embodiments, the user may transmit the connection verification information of the first Internet of Things device to the second Internet of Things device after determining the connection verification information of the first Internet of Things device, so that the second Internet of Things device can obtain the connection verification information. There are multiple manners in which the user may determine the connection verification information of the first Internet of Things device. For example, the user may view fixed connection verification information in the device package of the first Internet of Things device. For another example, the user may obtain the connection verification information of the first Internet of Things device via a first Internet of Things APP paired with the first Internet of Things device. For example, the user may obtain the connection verification information generated by the first Internet of Things APP, or interrogate the connection verification information of the first Internet of Things device via the first Internet of Things APP. Alternatively, if the connection verification information is generated by the first Internet of Things APP, the first Internet of Things APP may transmit the connection verification information to the first Internet of Things device via the first cloud server.

In the present embodiment, there may be multiple manners in which the second Internet of Things device obtains the connection verification information of the first Internet of Things device by a user. For example, the user may directly interact at the second Internet of Things device to transmit the connection verification information of the first Internet of Things device to the second Internet of Things device. Specifically, the step of “obtaining the connection verification information of the first Internet of Things device” may include:
obtaining connection verification information of the first Internet of Things device responsive to an information inputting operation for the second Internet of Things device.

An information input operation for the second Internet of Things device may be a specific touch operation, such as a long-press operation, a double-click operation, a slide operation, or the like. The information input operation for the hub node may further be a non-touch operation, such as a voice trigger operation, an image detection trigger operation, a program trigger operation, or the like. Alternatively, the information input operation for the second Internet of Things device may be a combination of a series of operations, which is not limited in the present embodiment.

For example, the second Internet of Things device may include a physical control through which a user may perform an information input operation to input connection verification information of the first Internet of Things device; for another example, the second Internet of Things device may include a display screen on which a user may input connection verification information of a first Internet of Things device by performing a touch operation or scanning a code; for another example, the second Internet of Things device may include a voice interaction module, and the user may perform an information input operation for the second Internet of Things device by performing voice interaction with the second Internet of Things device, thereby inputting connection verification information of the first Internet of Things device; for another example, the second Internet of Things device may include an image recognition module, and the user may transmit an image including the connection verification information to the second Internet of Things device so that the second Internet of Things device may recognize the connection verification information of the first Internet of Things device through the image recognition module; for another example, the user may transmit the connection verification information of the first Internet of Things device to the second Internet of Things device through a near field communication technology; and so on.

In another embodiment, the user may further transmit the connection verification information of the first Internet of Things device to the second Internet of Things device. Specifically, the step of “obtaining the connection verification information of the first Internet of Things device” may include:
obtaining connection verification information transmitted by a target client, where the target client is a client matching the second Internet of Things device, and the connection verification information is connection verification information corresponding to the first Internet of Things device.

As an example, the target client may be a second Internet of Things app, and the user may, after determining the connection verification information of the first Internet of Things device, input the connection verification information into the second Internet of Things app, and transmit the connection verification information to the second Internet of Things device via the second Internet of Things app, so that the second Internet of Things device may obtain the connection verification information of the first Internet of Things device.

In the present application, after the connection relationship between the second Internet of Things device and the first Internet of Things device is established, the access information for the second cloud server can be further transmitted to the first Internet of Things device based on the connection relationship. Specifically, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting and receiving the access information for the second cloud server.

At step 202, authentication result information of the first Internet of Things device transmitted by the second cloud server may be received.

The authentication result information of the first Internet of Things device is used to describe an authentication result of the second cloud server to the first Internet of Things device. For example, the authentication result information may include an authentication result of the second cloud server to the first Internet of Things device, such as the authentication being passed or the authentication failure; for another example, the authentication result information may include a device identification of the first Internet of Things device; for another example, the authentication result information may include authentication time; and so on.

In the present application, since the second cloud server is a cloud server having a trust relationship with the second Internet of Things device, after the second cloud server authenticates the first Internet of Things device to obtain the authentication result information of the first Internet of Things device, the second cloud server may transmit the authentication result information to the second Internet of Things device, and correspondingly, the second Internet of Things device may receive the authentication result information of the first Internet of Things device transmitted by the second cloud server.

At step 203, if the authentication result information is that the authentication is passed, authority information for the first Internet of Things device may be set.

In the present application, there may be multiple manners in which the second Internet of Things device sets the authority information for the first Internet of Things device. For example, the device control information may be transmitted to the first Internet of Things device to set the authority information of the second Internet of Things device for the first Internet of Things device. For example, the second Internet of Things device may transmit the device control information to the first Internet of Things device by interaction between the terminal and the server.

For another example, the second Internet of Things device may transmit device control information to the first Internet of Things device based on the connection relationship established between the second Internet of Things device and the first Internet of Things device. Specifically, the step of “setting authority information for the first Internet of Things device” may include:
transmitting device control information to the first Internet of Things device to set authority information for the first Internet of Things device with the device control information, where the device control information is configured to instruct the first Internet of Things device to set a control authority, the control authority being a device control authority of the second Internet of Things device for the first Internet of Things device.

Since it is considered that the second Internet of Things device needs to learn the device capability of the first Internet of Things device before further generating the device control information, the device capability information of the first Internet of Things device may be determined before the second Internet of Things device transmits the device control information to the first Internet of Things device, so that the second Internet of Things device may further generate the device control information for the first Internet of Things device. Specifically, before the step of “the transmitting of the device control information to the first Internet of Things device”, the apparatus for setting the device control authority can further include:
determining device capability information of the first Internet of Things device; and
generating device control information for the first Internet of Things device based on the device capability information.

There may be multiple manners in which the second Internet of Things device determines device capability information of the first Internet of Things device. For example, the device capability information can be determined by requesting device capability information of the first Internet of Things device to the first Internet of Things device. Specifically, the step of “determining the device capability information of the first Internet of Things device” may include:
generating a device capability request for the first Internet of Things device to transmit the device capability request to the first Internet of Things device; and
receiving device capability information returned by the first Internet of Things device based on the device capability request.

In order to ensure the security of the data interaction, the second Internet of Things device and the first Internet of Things device may make an agreement on a format of the device capability request, so that the second Internet of Things device may request to obtain a capability model of the first Internet of Things device by generating a device capability request meeting a preset agreement format and transmitting the device capability request to the first Internet of Things device.

As an example, referring to FIG. 3, the second Internet of Things device may be a third party local hub shown by 1003, and the first Internet of Things device may be an IoT device shown by 1001, where the third party local hub may generate a device capability request for the IoT device in a pre-agreed format and transmit the device capability request to the IoT device. Further, the third party local hub may receive device capability information returned by the IoT device based on the device capability request, where the device capability information may specifically include a specific model, a type, a controllable instruction, an attribute, a service, and the like of the IoT device.

After determining the device capability information of the first Internet of Things device, the second Internet of Things device can generate device control information for the first Internet of Things device based on the device capability information.

There may be multiple manners of generating the device control information for the first Internet of Things device based on the device capability information. For example, the device control information of the second Internet of Things device to the first Internet of Things device may be generated based on the device capability information for the first Internet of Things device, where the device control information is the device control information bound to the second Internet of Things device, for example, the device control information bound to the device identification of the second Internet of Things device. In this case, the device control information of the second Internet of Things device to the first Internet of Things device may also remain unchanged even if the device control object for performing device control of the first Internet of Things device via the second Internet of Things device is changed.

For another example, in a practical application, considering that the second Internet of Things device can be used as a physical medium via which different device control objects controls the first Internet of Things device, and the different device control objects have different device control requirements for the first Internet of Things device, it is possible to generate device control information corresponding to each of different device control objects for the second Internet of Things device based on the device capability information of the first Internet of Things device in the Internet of things system to which the second Internet of Things device belongs. Specifically, the step of “generating device control information for the first Internet of Things device based on the device capability information” may include:
determining a device control object of the second Internet of Things device, where the device control object is an object that controls the first Internet of Things device via the second Internet of Things device; and
generating device control information of the device control object in a target Internet of Things system to the first Internet of Things device based on the device capability information, where the target Internet of Things system is an Internet of Things system to which the second Internet of Things device belongs.

There may be multiple manners of determining the device control object for the second Internet of Things device. For example, the device control object for the second Internet of Things device may be determined by interacting the second Internet of Things system with the Internet of Things system to which the second Internet of Things device belongs, i.e., the target Internet of Things system; for another example, the device control object for the second Internet of Things device may be determined by interacting the user with the second Internet of Things system; for another example, the device control object for the second Internet of Things device may be determined by the second Internet of Things device based on current device data of the second Internet of Things device; and so on.

In a practical application, the second Internet of Things device may allocate different object identification to different device control objects in the target Internet of Things system. For example, the third party local hub may allocate different subject IDs to different controllers, users, etc., within its own ecology.

After the device control object of the second Internet of Things device is determined, the device control information of the device control object in the target Internet of Things system to the first Internet of Things device can be further generated based on the device capability information.

For example, the second Internet of Things device may determine, based on the device capability information of the first Internet of Things device, a service accessible to the first Internet of Things device and an authority for the accessible service in services provided by the second Internet of Things device to determine the service accessing information of the device control object. Further, the device control information of the device control object in the target Internet of Things system to the first Internet of Things device can be further generated based on the service accessing information of the device control object. Specifically, the step of “generating device control information of the device control object in a target Internet of Things system to the first Internet of Things device based on the device capability information” may include:
determining a service provided by the first Internet of Things device based on the device capability information;
determining service accessing information of the device control object to the service; and
generating device control information of the device control object in the target Internet of Things system to the first Internet of Things device based on the service accessing information.

The device capability information of the first Internet of Things device is related information describing the device capability that can be provided by the first Internet of Things device. For example, the device capability information may include a specific model, a type, a controllable instruction, an attribute, a service, and the like of the device. Therefore, a service provided by the first Internet of Things device can be determined based on the device capability information. As an example, device capability information of the intelligent air conditioner can be used to determine services provided by intelligent air conditioner, including a refrigeration service, a heating service, a dehumidification service, a self-cleaning service, and the like.

There may be multiple manners of determining the service accessing information of the device control object. For example, the service accessing information of the device control object may be determined by interacting the second Internet of Things system with the Internet of Things system to which the second Internet of Things device belongs, i.e., the target Internet of Things system; for another example, the service accessing information of the device control object may be determined by interacting the user with the second Internet of Things system; for another example, the service accessing information of the device control object may be determined by the second Internet of Things device based on current device data of the second Internet of Things device; and so on.

The second Internet of Things device may add the system identification of the target Internet of Things system, the object identification of the device control object, and the service accessing information of the device control object into the device control information of the second Internet of Things device to generate the device control information of the device control object in the target Internet of Things system to the first Internet of Things device. In this case, after obtaining the device control information, the first Internet of Things device can correspondingly set the device control authority of the device control object in the target Internet of Things system for the first Internet of Things device based on the system identification and the object identification.

For example, the third party local hub may add an ecological identification code of the third party local hub, the object identification of the device control object, and the service accessing information into the device control information of the third party local hub to generate the device control information of the device control object in the ecology in which the third party local hub is located to the IoT device, where the service accessing information may include an accessible service and an authority for the service. In this case, after obtaining the device control information, the IoT device may set the device control authority of the device control object in the ecology for the IoT device based on the ecological identification code and the subject ID.

In a practical application, it is considered that the device control object may have an information changing authority for the first Internet of Things device in addition to the service calling authority for the first Internet of Things device. Accordingly, the second Internet of Things device may correspondingly set the information into the device control information, for example, may set the information by the object attribute information of the device control object. In this way, the second Internet of Things device can set the object attribute of the device control object so that the first Internet of Things device learns whether the device control object has the information changing authority. Specifically, the step of “generating device control information of the device control object in the target Internet of Things system to the first Internet of Things device” can include:
determining object attribute information of the device control object; and
generating device control information of the device control object in the target Internet of Things system to the first Internet of Things based on the object attribute information.

Similarly, there may be multiple manners of determining the object attribute information of the device control object. For example, the object attribute information of the device control object may be determined by interacting the second Internet of Things system with the Internet of Things system to which the second Internet of Things device belongs, i.e., the target Internet of Things system; for another example, the object attribute information of the device control object may be determined by interacting the user with the second Internet of Things system; for another example, the object attribute information of the device control object may be determined by the second Internet of Things device based on current device data of the second Internet of Things device; and so on.

As an example, the second Internet of Things device further adds object attribute information of the device control object into the device control information of the second Internet of Things device to generate device control information of the device control object in the target Internet of Things system to the first Internet of Things device. In this case, after obtaining the device control information, the first Internet of Things device may determine whether the device control object has an information changing authority for the first Internet of Things device based on the object attribute information.

For example, the third party local hub may further add role information of the device control object into the device control information of the third party local hub to generate the device control information of the device control object in the ecology in which the third party local hub is located to the IoT device. In this case, after obtaining the device control information, the IoT device may determine whether the device control object has an information changing authority for the IoT device based on the object attribute information.

In a practical application, the device control information generated by the second Internet of Things device may further include information such as a device ID, a connection key, and a key expiration time of the connection key, in addition to a system identification of a second Internet of Things system, a subject ID of the device control object, object attribute information, and service accessing information.

In the present application, after generating the device control information for the first Internet of Things device, the second Internet of Things device may transmit the device control information to the first Internet of Things device. There may be multiple manners in which the second Internet of Things device may transmit the device control information to the first Internet of Things device. For example, the second Internet of Things device may generate a device control packet, where the device control packet may carry the device control information. In this case, the second Internet of Things device may transmit the device control information to the first Internet of Things device by transmitting the device control packet to the first Internet of Things device. Specifically, the step of “transmitting the device control information to the first Internet of Things device” may include:
generating a device control packet, where the device control packet includes device control information of the second Internet of Things device for the first Internet of Things device; and
transmitting device control packet to the first Internet of Things device.

In the embodiment, the process of setting the device control authority is described above from the perspective of the second Internet of Things device. In a practical application, the device control may be further performed on the basis of the foregoing process. Specifically, the method for setting the device control authority may further include:
transmitting a device control instruction to the first Internet of Things to perform device control for the first Internet of Things via the device control instruction.

In the present application, there may be a plurality of manners in which the second Internet of Things device can transmit a device control instruction to the first Internet of Things device. For example, the step of “transmitting the device control instruction to the first Internet of Things device” can include:
transmitting a device control instruction to a second pairing server to transmit the device control instruction to the first Internet of Things device via the second pairing server, where the second pairing server is a cloud server paired with the second Internet of Things device.

For another example, the step of “transmitting the device control instruction to the first Internet of Things device” may include:
transmitting a device control instruction to a second pairing server to transmit the device control instruction to a first pairing server via the second pairing server and transmit the device control instruction to the first Internet of Things via the first pairing server, where the second pairing server is a cloud server paired with the second Internet of Things, and the first pairing server is a cloud server paired with the first Internet of Things.

For another example, referring to FIG. 6, the second Internet of Things device may establish a control connection relationship with the first Internet of Things device, so that a device control instruction may be transmitted to the first Internet of Things device based on the control connection relationship. Specifically, the step of “transmitting a device control instruction to the first Internet of Things device” can include:
establishing a control connection relationship with the first Internet of Things device, where the control connection relationship is configured for the second Internet of Things device to perform device control for the first Internet of Things device; and
transmitting a device control instruction to the first Internet of Things device based on the control connection relationship.

There are multiple manners in which the second Internet of Things device may establish the control connection relationship with the first Internet of Things device. For example, since the device control information transmitted by the second Internet of Things device to the first Internet of Things device may include an object identification of the device control object and connection key information corresponding to the device control object, the control connection relationship with the first Internet of Things device may be established based on the object identification and the connection key information. Specifically, the step of “establishing the control connection relationship with the first Internet of Things device” can include:
establishing a connection relationship with the first Internet of Things device based on the object identification and the connection key information.

For example, the second Internet of Things device and the first Internet of Things device may perform security negotiation with the objection identification and the connection key information to establish an encrypted connection, so as to establish a control connection relationship between the second Internet of Things device and the first Internet of Things device. It should be noted that the method for establishing the control connection relationship herein may be the same as or different from the method for establishing the connection relationship in the configuration process in the foregoing description, which is not limited in the present application.

In some embodiments, since it is considered in a practical application that the second Internet of Things device may have set its device control authorities for a plurality of first Internet of Things devices across different Internet of Things systems, and the second Internet of Things device may request to establish a control connection relationship with each of the plurality of first Internet of Things devices and correspondingly receive control connection response information returned by the first Internet of Things device in the process of control, where the control connection response information may include a first device identification corresponding to the first Internet of Things device. Therefore, when the second Internet of Things device wants to establish a control connection relationship between the second Internet of Things device and the target first Internet of Things device, the second Internet of Things device may determine whether the first Internet of Things device transmitting the control connection response information is a target first Internet of Things device by comparing the target device identification of the target first Internet of Things device with the first device identification in the control connection response information, so that the control connection relationship between the second Internet of Things device and the target first Internet of Things device can be further established. Specifically, the device control information of the second Internet of Things device transmitted to the first Internet of Things device may further include a system identification of an Internet of Things system to which the second Internet of Things object belongs, i.e., a target system identification of the target Internet of Things system, and a target device identification allocated by the target Internet of Things system for the first Internet of Things device in addition to the object identification of the device control object and the connection key information corresponding to the device control object. Specifically, the step of “establishing a connection relationship with the first Internet of Things device based on the object identification and the connection key information” can include:
generating a control connection request to transmit the control connection request to the first Internet of Things device, where the control connection request comprises the target system identification;
receiving control connection response information transmitted by the target controlled device, where the control connection response information comprises a first device identification corresponding to the target controlled device; and
in response to the first device identification matching the target device identification, establishing a control connection relationship with the target controlled device based on the object identification and the connection key information.

The control connection request generated by the second Internet of Things device is configured to request to establish a control connection relationship between the second Internet of Things device and the first Internet of Things device. The control connection request may include a target system identification, where the target system identification is the system identification of the Internet of Things system to which the second Internet of Things device generating the control connection request belongs.

In the process of controlling the first Internet of Things device via the second Internet of Things device, the second Internet of Things device may generate and transmit a control connection request to the first Internet of Things device. Therefore, the second Internet of Things device may transmit a control connection request to a plurality of first Internet of Things device, and correspondingly, the second Internet of Things device may receive control connection response information from different first Internet of Things device, where the control connection response information includes a first device identification corresponding to the first Internet of Things device. The second Internet of Things device may compare the first device identification corresponding to each piece of control connection response information with the target device identification. If the first device identification and the target device identification match each other, it may be determined that the first Internet of Things device transmitting the control connection response information is the first Internet of Things device with which the second Internet of Things device wants to establish a control connection relationship. The second Internet of Things device can further establish a control connection relationship with the first Internet of Things device based on the object identification and the connection key information.

As an example, the second Internet of Things device may transmit a multicast or broadcast packet by means of a multicast packet or the like within a local area network, so as to transmit a control connection request to the first Internet of Things device, where the control connection request includes a target system identification being a device identification of an Internet of things system to which the second Internet of Things device belongs, and a format of the packet is agreed in advance. Accordingly, the first Internet of Things device can obtain the control connection request and return control connection response information including the first device identification corresponding to the first Internet of Things device to the second Internet of Things device. The second Internet of Things device may compare the first device identification with the target device identification, and if the first device identification and the target device identification are matched with each other, the second Internet of Things device may further establish a control connection relationship with the first Internet of Things device based on the object identification and the connection key information.

After the control connection relationship between the second Internet of Things device and the first Internet of Things device is established, the second Internet of Things device can transmit the device control instruction to the first Internet of Things device based on the control connection relationship. Specifically, after the connection relationship between the second Internet of Things device and the first Internet of Things device is established, i.e., a connection channel for data interaction between the second Internet of Things device and the first Internet of Things device may be established, the second Internet of Things device and the first Internet of Things device may perform data interaction via the connection channel, for example, transmitting device control packet and receiving the device control packet.

Specifically, the step of “transmitting the device control instruction to the first Internet of Things device” may include:
determining a device control object of the first Internet of Things device;
in response to the device control object having an information changing authority to the first Internet of Things device, generating a device control instruction based on the information changing authority; and
transmitting the device control instruction to the first Internet of Things device.

There may be multiple manners in which the second Internet of Things device determines the device control object for the first Internet of Things device. For example, the device control object for the first Internet of Things device may be determined by interacting the second Internet of Things system with the Internet of Things system to which the second Internet of Things device belongs, i.e., the target Internet of Things system; for another example, the device control object for the first Internet of Things device may be determined by interacting the user with the second Internet of Things system; for another example, the device control object for the first Internet of Things device may be determined by the second Internet of Things device based on current device data of the second Internet of Things device; and so on.

Further, the second Internet of Things device may determine whether the device control object has an information changing authority, for example, based on an object attribute of the device control object. Specifically, if the device control object has an information changing authority for the first Internet of Things device, then the second Internet of Things device can generate a device control instruction based on the information changing authority, for example, an information changing instruction, and transmit the device control instruction to the first Internet of Things device, so the second Internet of Things device can change the device control information stored in the first Internet of Things device with the device control instruction.

As an example, the device control object of the second Internet of Things device may be a third party local hub F whose an object attribute is an administrator. That is, the third party local hub F has the information changing authority for the first Internet of Things device. In this example, the third party local hub F may periodically generate and transmit a device control instruction to the first Internet of Things device, where the device control instruction may include an ACL packet and an object identification of the third party local hub F, the object identification is used for the first Internet of Things device to determine that the third party local hub has an information changing authority, and the ACL packet is used for the first Internet of Things device to update its ACL.

In the embodiments of the present application, the description of each of the embodiments has its own emphasis. For a part not described in detail in the explanation of a certain step or a certain term in a certain embodiment, reference may be made to the above detailed description of the method for setting the device control authority, which is not repeatedly described herein.

As can be seen from above that any one of the embodiments of the present application can enable the second Internet of Things device that belongs to the different Internet of Things system than the first Internet of Things device to set the device control authority for the first Internet of Things device, thereby implementing device control in a scenario across the Internet of Things systems. In addition, any one of the embodiments of the present application can, before setting the device control authority of the second Internet of Things device for the first Internet of Things device, authenticate the second Internet of Things device by interacting with a cloud server trusted by the second Internet of Things device, which not only enhances the security of device control, but also reduces the cost requirement for the second Internet of Things device. For example, the second Internet of Things device does not need to use a security chip, or prepares a certificate key locally. Therefore, device control across the Internet of Things systems can be efficiently and securely realized.

In addition, compared with the protocol interconnection or standardization between one cloud and another cloud or between an end and one cloud, the present embodiment avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, any of the embodiments of the present application can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

In accordance with the methods described in the above embodiments, further details are given below by way of example.

The present embodiment will be described from the perspective of a third setting apparatus, which may be specifically integrated in a server. For example, the third setting apparatus may be specifically integrated in a second cloud server.

As shown in FIG. 8, a method for setting a device control authority includes steps 301-303 as follows.

At step 301, an access connection relationship between the second cloud server and the first Internet of Things device is established in response to an access request transmitted by the first Internet of Things device based on access information, where the second cloud server is a cloud server having a trust relationship with the second Internet of Things device, the access information is information transmitted by the second Internet of Things device to the first Internet of Things device, and the second Internet of Things device and the first Internet of Things device belong to different Internet of Things systems.

For example, the second cloud server may receive an access request transmitted by the first Internet of Things device based on the access information, where the access request may carry an access request parameter.

It should be noted in an actual application that the second cloud server and the first Internet of Things device may make a pre-agreement on the format of the access request, so that the second cloud server may, after receiving the access request, determine whether the access request is legal by determining whether the format of the access request matches the pre-agreement format. Further, if the access request is legal, the second cloud server may allow the first Internet of Things device to access the second cloud server, thereby establishing an access connection relationship between the first Internet of Things device and the second cloud server.

In some embodiments, the access request parameter may be a binding code for the first Internet of Things device, which may be used not only as a parameter for the first Internet of Things device to be connected to the second cloud server, but also for the second cloud server to bind the first Internet of Things device to a target user. Specifically, the target user here may be an associated user of the second Internet of Things device, for example, a user currently logged in on the second Internet of Things device.

At step 302, the first Internet of Things device may be authenticated based on the access connection relationship.

In a practical application, there may be multiple manners in which the second cloud server may authenticate the first Internet of Things device, which may include, for example, certificate authentication, key authentication, and the like. Similar to a manner in which the first Internet of Things device authenticates the second cloud server, the second cloud server authenticates the first Internet of Things device. The device authentication information of the first Internet of Things device may be verified, and the authentication result of the first Internet of Things device can be determined based on the verification result of the device authentication information, thereby implementing authentication of the first Internet of Things device. Additionally, the access connection relationship established between the second cloud server and the first Internet of Things device may implement data interaction between the second cloud server and the first Internet of Things device, for example, transmitting and receiving device authentication information of the first Internet of Things device. Therefore, specifically, the step of “authenticating the first Internet of Things device based on the access connection relationship” may include:
obtaining device authentication information of the first Internet of Things device based on the access connection relationship; and
authenticating the first Internet of Things device based on the device authentication information.

The device authentication information of the first Internet of Things device is related data required for the second cloud server to authenticate the first Internet of Things device. For example, the second cloud server may verify the device authentication information to obtain a verification result of the device authentication information, and further determine the authentication result of the first Internet of Things device according to the verification result.

In the present application, the access connection relationship between the first Internet of Things device and the second cloud server is established, that is, a connection channel for data interaction between the first Internet of Things device and the second cloud server can be established. As such, the first Internet of Things device and the second cloud server can perform data interaction through the connection channel, for example, transmitting and receiving device authentication information. Therefore, the second cloud server may obtain device authentication information of the first Internet of Things device based on the access connection relationship between the second cloud server and the first Internet of Things device.

Further, the second cloud server may authenticate the first Internet of Things device based on the device authentication information of the first Internet of Things device.

Similar to the manner in which the first Internet of Things device may authenticate the second cloud server based on the device authentication information of the second cloud server, there may be multiple manners in which the second cloud server may authenticate the first Internet of Things device based on the device authentication information of the first Internet of Things device. For example, the second cloud server may verify the device authentication information of the first Internet of Things device and determine the authentication result of the first Internet of Things device based on the verification result. There may be multiple manners of verifying the device authentication information, for example, which may include comparing the device authentication information, calculating the device authentication information, querying and matching the device authentication information, and the like.

Since it is considered that verifying the device authentication information is essentially the process of authenticating the first Internet of Things device, it is possible to first determine related information required for authenticating the first Internet of Things device, and further perform information verification for the device authentication information with the related information. Specifically, the step of “authenticating the first Internet of Things device based on the device authentication information” may include:
determining authentication verification information required for authenticating the first Internet of Things device; and
performing information verification for the device authentication information with the authentication verification information to authenticate the first Internet of Things device.

A manner in which the second cloud server determines the authentication verification information required for authenticating the first Internet of Things device may specifically refer to the manner in which the first Internet of Things device determines the authentication verification information required for authenticating the second cloud server, which is not repeatedly described in the present application.

Similarly, a manner in which the second cloud server performs information verification for the device authentication information of the first Internet of Things device with the authentication verification information may specifically refer to the manner in which the first Internet of Things device performs information verification for the device authentication information of the second cloud server with the authentication verification information, which is not repeatedly described in the present application.

At step 303, if the authentication is passed, authentication result information of the first Internet of Things device may be transmitted to the second Internet of Things device to trigger the second Internet of Things device to set authority information for the first Internet of Things device based on the authentication result information.

In the present application, if the second cloud server has authenticated the first Internet of Things device, the second cloud server may transmit the authentication result information of the first Internet of Things device to the second Internet of Things device, so that the second Internet of Things device learns that the first Internet of Things device has authenticated the first Internet of Things device and further sets the authority information of the second Internet of Things device for the first Internet of Things device.

In the embodiments of the present application, the description of each of the embodiments has its own emphasis. For a part not described in detail in the explanation of a certain step or a certain term in a certain embodiment, reference may be made to the above detailed description of the method for setting the device control authority, which is not repeatedly described herein.

Any one of the embodiments of the present application can enable the second Internet of Things device that belongs to the different Internet of Things system than the first Internet of Things device to set the device control authority for the first Internet of Things device, thereby implementing device control in a scenario across the Internet of Things systems. In addition, any one of the embodiments of the present application can, before setting the device control authority of the second Internet of Things device for the first Internet of Things device, authenticate the second Internet of Things device by interacting with a cloud server trusted by the second Internet of Things device, which not only enhances the security of device control, but also reduces the cost requirement for the second Internet of Things device. For example, the second Internet of Things device does not need to use a security chip, or prepares a certificate key locally. Therefore, device control across the Internet of Things systems can be efficiently and securely realized.

In accordance with the methods described in the above embodiments, further details are given below by way of example.

In the present embodiment, an example in which the first setting apparatus is specifically integrated in one terminal, the second setting apparatus is specifically integrated in another terminal, and the third setting apparatus is specifically integrated in a server may be taken for illustration. For example, the first setting apparatus may be specifically integrated in the first Internet of Things device, the second setting apparatus may be specifically integrated in the second Internet of Things device, and the third setting apparatus may be specifically integrated in the second cloud server.

As shown in FIG. 8, a method for setting a device control authority includes steps 401-408 as follows.

At step 401, a connection relationship between the first Internet of Things device and the second Internet of Things device may be established, where the first Internet of Things device and the second Internet of Things device belong to different Internet of Things systems.

At step 402, the second Internet of Things device may transmit access information for the second cloud server to the first Internet of Things device based on the connection relationship, where the second cloud server is a cloud server having a trust relationship with the second Internet of Things device.

As an example, the access information of the second cloud server may include access address information and access parameter information. Specifically, the access address information may be a URL, and the access parameter information may be a binding code.

At step 403, an access connection relationship between the first Internet of Things device and the second cloud server may be established by an access request generated based on the access information.

In some embodiments, the first Internet of Things device may be connected to the second cloud server by a URL with a binding code used as a parameter. As an example, the first Internet of Things device may generate an access request carrying the binding code, and may determine a destination address of the access request with the URL to transmit the access request to the second cloud server to request to establish an access connection relationship with the second cloud server.

At step 404, the first Internet of Things device transmits device authentication information of the first Internet of Things device to the second cloud server based on the access connection request, and the second cloud server transmits device authentication information of the second cloud server to the first Internet of Things device based on the access connection request.

As an example, the second Internet of Things device may delegate authentication with the first Internet of Things device to the second cloud server for execution, so that the first Internet of Things device may perform mutual authentication with the second Internet of Things device by mutual authentication with the second cloud server.

At step 405, the first Internet of Things device may authenticate the second cloud server based on the device authentication information of the second cloud server.

In a practical application, there may be multiple manners in which the first Internet of Things device may authenticate the second cloud server, which, for example, may be implemented by certificate authentication, or may be implemented by key authentication, or the like.

At step 406, the second cloud server may authenticate the first Internet of Things device based on the device authentication information of the first Internet of Things device.

Similarly, there may be multiple manners in which the second cloud server may authenticate the first Internet of Things device, which, for example, may be implemented by certificate authentication, may be implemented by key authentication, and the like.

At step 407, if the authentication of the second cloud server to the first Internet of Things device is passed, the second cloud server transmits the authentication result information of the first Internet of Things device to the second Internet of Things device.

At step 408, if the authentication of the first Internet of Things device to the second cloud server is passed, the second Internet of Things device sets authority information of the second Internet of Things device for the first Internet of Things device.

In the embodiments of the present application, the description of each of the embodiments has its own emphasis. For a part not described in detail in the explanation of a certain step or a certain term in a certain embodiment, reference may be made to the above detailed description of the method for setting the device control authority, which is not repeatedly described herein.

As can be seen from above that any one of the embodiments of the present application can enable the second Internet of Things device that belongs to the different Internet of Things system than the first Internet of Things device to set the device control authority for the first Internet of Things device, thereby implementing device control in a scenario across the Internet of Things systems. In addition, any one of the embodiments of the present application can, before setting the device control authority of the second Internet of Things device for the first Internet of Things device, authenticate the second Internet of Things device by interacting with a cloud server trusted by the second Internet of Things device, which not only enhances the security of device control, but also reduces the cost requirement for the second Internet of Things device. For example, the second Internet of Things device does not need to use a security chip, or prepares a certificate key locally. Therefore, device control across the Internet of Things systems can be efficiently and securely realized.

In addition, compared with the protocol interconnection or standardization between one cloud and another cloud or between an end and one cloud, the present embodiment avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, any of the embodiments of the present application can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

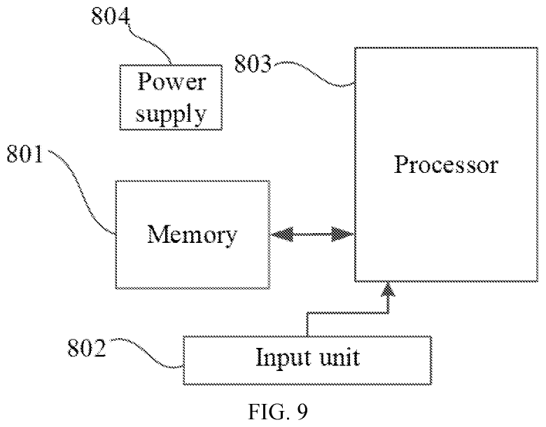

In addition, another embodiment of the present application further provides a computer device, which may be a device such as a terminal. As shown in FIG. 9, which shows a schematic structural diagram of the computer device according to some embodiments of the present application.

The computer device may include components such as a memory 801 including one or more computer readable storage media, an input unit 802, a processor 803 including one or more processing cores, and a power supply 804. It should be understood by those skilled in the art that the structure of the computer device shown in FIG. 9 should be not constituted to be a limitation on the computer device, and may include more or less components than illustrated, or may combine certain components, or different component arrangements.

The memory 801 may be used to store software programs and modules, and the processor 803 executes various functional applications and data processing by running the software programs and modules stored in the memory 801. The memory 801 may mainly include a storage program area and a storage data area, where the storage program area may store an operating system, a computer program (such as a sound play function, an image play function, and the like) required by at least one function, and the like; and the storage data area may store data (such as audio data, a phone book, and the like) created according to use of a computer device, and the like. In addition, memory 801 may include a high speed random access memory, and may also include a non-volatile memory, such as at least one magnetic disk storage device, a flash memory device, or other volatile solid state storage device. Correspondingly, the memory 801 may further include a memory controller to provide access to the memory 801 by the processor 803 and the input unit 802.

The input unit 802 can be configured to receive input number or character information and to generate keyboard, mouse, joystick, optical or trajectory ball signal inputs related to a user's setting and functional control. In detail, in a specific embodiment, the input unit 802 can include a touch-sensitive surface and other input devices. The touch-sensitive surface, also called a touch display screen or a touch panel, can be configured to detect touch operations of a user on or near the touch-sensitive surface (for example, operations carried out by the user through any suitable objects or attachments, such as a finger, a touch pen and the like, on the touch-sensitive surface or near the touch-sensitive surface) and to drive a corresponding device connected therewith according to a preset program. Optionally, the touch-sensitive surface can include a touch detection device and a touch controller. The touch detection device detects the touch direction of the user, detects a signal caused by the touch operation, and transmits the signal to the touch controller. The touch controller receives touch information from the touch detection device, converts the touch information into a contact coordinate, and then transmits the contact coordinate to the processor 803 and can receive a command transmitted by the processor 803 and execute the command. Moreover, the touch-sensitive surface can be one of various types, such as a resistance type, a capacitance type, an infrared type, a surface acoustic wave type and the like. Besides the touch-sensitive surface, the input unit 802 can further include the other input devices. In detail, other input devices can include, but is not limited to, one or more of a physical keyboard, function keys (such as a volume control key, a switching key and the like), a trackball, a mouse, a joystick and the like.

The processor 803 is a control center of the computer device. The processor 603 is connected to various parts of the entire mobile phone by various interfaces and lines, and performs various functions of the computer device and processes data by running or executing software programs and/or modules stored in the memory 801 and invoking data stored in the memory 801, thereby monitoring the mobile phone as a whole. Alternatively, the processor 803 may include one or more processing cores. Preferably, the processor 803 may integrate an application processor and a modem processor, where the application processor mainly processes an operating system, a user interface, a computer program, and the like, and the modem processor mainly processes wireless communication. It should be understood that the modulation/demodulation processor can be independent from the processor 803.

The computer device further includes a power supply 804 (such as a battery) for supplying power to the respective components. Preferably, the power supply may be logically connected to the processor 803 by the power supply management system, so that functions such as charging, discharging, and power consumption management are managed by the power supply management system. The power supply 804 may further include one or more direct current (DC)/or alternating current (AC) power sources, recharging system, power failure detection circuit, power converter or inverter, power supply status indicator, and the like.

Although not shown, the computer device may further include a camera, a BLUETOOTH module, and so on, which are not repeated herein. In the present embodiment, the processor 803 in the computer device may load executable files corresponding to processes of one or more computer programs into the memory 801 according to the following instructions, and the processor 803 executes the computer programs stored in the memory 801 to implement various functions including:
receiving access information for a second cloud server transmitted by a second Internet of Things device that has established a connection relationship with the first Internet of Things device, where the first Internet of Things device and the second Internet of Things device belong to different Internet of Things systems, and the second cloud server is a cloud server having a trust relationship with the second Internet of Things device; obtaining device authentication information of the second cloud server according to the access information; authenticating the second cloud server based on the device authentication information; and in response to the authentication being passed, setting authority information of the second Internet of Things device to the first Internet of Things device.

Alternatively, the program instructions can perform following operations including:
in response to an access request transmitted by the first Internet of Things device based on access information, establishing an access connection relationship between the second cloud server and the first Internet of Things device, where the second cloud server is a cloud server having a trust relationship with the second Internet of Things device, the access information is information transmitted by the second Internet of Things device to the first Internet of Things device, and the second Internet of Things device and the first Internet of Things device belong to different Internet of Things systems; authenticating the first Internet of Things device based on the access connection relationship; and in response to the authentication being passed, transmitting authentication result information of the first Internet of Things device to the second Internet of Things device to trigger the second Internet of Things device to set authority information for the first Internet of Things device based on the authentication result information.

Alternatively, the program instructions can perform following operations including:

Transmitting access information for a second cloud server to a first Internet of Things device that has established a connection relationship with the second Internet of Things device, where the access information is configured to establish an access connection relationship between the first Internet of Things device and the second cloud server, the access connection relationship is configured for the second cloud server to authenticate the first Internet of Things device, the second cloud server is a cloud server having a trust relationship with the second Internet of Things device, and the second Internet of Things device and the first Internet of Things device belong to different Internet of Things systems; receiving authentication result information of the first Internet of Things device transmitted by the second cloud server; and if the authentication result information is that the authentication is passed, setting authority information for the first Internet of Things device.

Implementation of above operations may refer to above embodiments, and is not repeated herein.

As can be seen from above that the solution of the computer device of any of the embodiments can enable the second Internet of Things device that belongs to the different Internet of Things system than the first Internet of Things device to set the device control authority for the first Internet of Things device, thereby implementing device control in a scenario across the Internet of Things systems. In addition, the computer device of any one of the embodiments can, before setting the device control authority of the second Internet of Things device for the first Internet of Things device, authenticate the second Internet of Things device by interacting with a cloud server trusted by the second Internet of Things device, which not only enhances the security of device control, but also reduces the cost requirement for the second Internet of Things device. For example, the second Internet of Things device does not need to use a security chip, or prepares a certificate key locally. Therefore, device control across the Internet of Things systems can be efficiently and securely realized.

In addition, compared with the protocol interconnection or standardization between one cloud and another cloud or between an end and one cloud, the computer device of any of the embodiments avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the computer device of any of the embodiments can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

A person of ordinary skill in the art may understand that all or some of the steps in various methods of the foregoing embodiments may be implemented by program instructions, or may be implemented by a program instructing relevant hardware. The program instructions may be stored in a computer readable storage medium, and be loaded and executed by a processor.

For this, another embodiment of the present application provides a storage medium, which stores a plurality of instructions that can be loaded by the processor to execute the steps of any of the methods provided in the embodiments of the present application. For example, the program instructions can perform following operations including:
receiving access information for a second cloud server transmitted by a second Internet of Things device that has established a connection relationship with the first Internet of Things device, where the first Internet of Things device and the second Internet of Things device belong to different Internet of Things systems, and the second cloud server is a cloud server having a trust relationship with the second Internet of Things device; obtaining device authentication information of the second cloud server according to the access information; authenticating the second cloud server based on the device authentication information; and in response to the authentication being passed, setting authority information of the second Internet of Things device for the first Internet of Things device.

Alternatively, the program instructions can perform following operations including:
in response to an access request transmitted by the first Internet of Things device based on access information, establishing an access connection relationship between the second cloud server and the first Internet of Things device, where the second cloud server is a cloud server having a trust relationship with the second Internet of Things device, the access information is information transmitted by the second Internet of Things device to the first Internet of Things device, and the second Internet of Things device and the first Internet of Things device belong to different Internet of Things systems; authenticating the first Internet of Things device based on the access connection relationship; and in response to the authentication being passed, transmitting authentication result information of the first Internet of Things device to the second Internet of Things device to trigger the second Internet of Things device to set authority information for the first Internet of Things device based on the authentication result information.

Alternatively, the program instructions can perform following operations including:

Transmitting access information for a second cloud server to a first Internet of Things device that has established a connection relationship with the second Internet of Things device, where the access information is configured to establish an access connection relationship between the first Internet of Things device and the second cloud server, the access connection relationship is configured for the second cloud server to authenticate the first Internet of Things device, the second cloud server is a cloud server having a trust relationship with the second Internet of Things device, and the second Internet of Things device and the first Internet of Things device belong to different Internet of Things systems; receiving authentication result information of the first Internet of Things device transmitted by the second cloud server; and if the authentication result information is that the authentication is passed, setting authority information for the first Internet of Things device.

Implementation of above operations may refer to above embodiments, and is not repeated herein.

The storage medium may include a Read Only Memory (ROM), a Random Access Memory (RAM), a magnetic disk, an optical disk, or the like.

Since the instructions stored in the storage medium can perform the steps in any of the methods provided in the embodiments of the present application, the advantageous effects achieved by the method provided in the embodiments of the present application can be realized. Please refer to the foregoing embodiments, of which details are not repeatedly described herein.

According to one aspect of the present application, a computer program product or a computer program is provided, including a computer instruction stored in a computer readable storage medium. A processor of a computer device reads the computer instruction from the computer readable storage medium and executes the computer instruction to cause the computer device to perform any of the methods provided in the various alternative implementations described in the embodiments of the present application.

The method and apparatus for setting the device control authority, the computer device, and the storage medium provided in the embodiments of the present application are described in detail above. A specific example is used herein to describe a principle and an implementation of the present application. The description of the foregoing embodiments is merely used to help understand a method and a core idea of the present application. In addition, an ordinary person skilled in the art may make changes in a specific implementation manner and an application scope according to an idea of the present application. In conclusion, content of this specification should not be construed as a limitation on the present application.

What is claimed is:

1. A method for setting a device control authority, the method being applied to a first Internet of Things device, comprising:
receiving access information for a second cloud server transmitted by a second Internet of Things device that has established a connection relationship with the first Internet of Things device, wherein the first Internet of Things device and the second Internet of Things device belong to different Internet of Things systems, and the second cloud server is a cloud server having a trust relationship with the second Internet of Things device;
obtaining device authentication information of the second cloud server based on the access information;
authenticating the second cloud server based on the device authentication information; and
in response to the authentication being passed, setting authority information of the second Internet of Things device for the first Internet of Things device.

2. The method of claim 1, wherein the authenticating of the second cloud server based on the device authentication information comprises:
determining authentication verification information required for verifying the second cloud server; and
performing information verification for the device authentication information with the authentication verification information to authenticate the second cloud server.

3. The method of claim 1, wherein the setting of authority information of the second Internet of Things device for the first Internet of Things device comprises:
if the authentication is passed, transmitting device capability information of the first Internet of Things device to the second Internet of Things device in response to a device capability request transmitted by the second Internet of Things device, wherein the device capability information is configured to instruct the second Internet of Things device to generate device control information for the first Internet of Things device, and the transmitting of the device capability information comprises:
receiving device capability request transmitted by the second Internet of Things device; and
in response to the device capability request, transmitting device capability information of the first Internet of Things device to the second Internet of Things device; and
receiving device control information transmitted by the second Internet of Things device to set authority information of the second Internet of Things device for the first Internet of Things device based on the device control information.

4. The method of claim 3, wherein the device control information comprises a system identification of a target Internet of Things system and an object identification of a device control object, the target Internet of Things system is an Internet of Things system to which the second Internet of Things device belongs, and the device control object is an object that controls the first Internet of Things device via the second Internet of Things device;
the setting of authority information of the second Internet of Things device for the first Internet of Things device based on the device control information comprises:
setting a device control authority of the device control object in the target Internet of Things system for the first Internet of Things device based on the system identification and the object identification.

5. The method of claim 4, wherein the device control information further comprises object attribute information of the device control object;
the setting of the device control authority of the device control object in the target Internet of Things system for the first Internet of Things device based on the system identification and the object identification comprises:
determining a service calling authority of the device control object for the first Internet of Things device based on the object attribute information, wherein the service calling authority is a calling authority of the device control object for a service provided by the first Internet of Things device, and the service provided by the first Internet of Things device is determined based on the device capability information of the first Internet of Things device; and
setting a device control authority of the device control object in the target Internet of Things system for the first Internet of Things device based on the service calling authority.

6. The method of claim 5, wherein the setting of the device control authority of the device control object in the target Internet of Things system for the first Internet of Things device based on the service calling authority comprises:
in response to the object attribute information indicating that the device control object has an information changing authority for the first Internet of Things device, setting a device control authority of the device control object in the target Internet of Things system for the first Internet of Things device based on the information changing authority and the service calling authority, wherein the information changing authority represents a changing authority of the device control object for the device control information stored in the first Internet of Things device.

7. The method of claim 1, further comprising:
receiving a device control instruction transmitted by the second Internet of Things device, wherein the device control instruction is configured for the second Internet of Things device to perform device control for the first Internet of Things device; and
executing an operation corresponding to the device control instruction;
wherein the device control instruction comprises an information changing instruction;
the executing of the operation corresponding to the device control instruction comprises:
determining a device control object corresponding to the device control instruction; and
in response to the device control object having an information changing authority for the first Internet of Things device, executing an information changing operation corresponding to the information changing instruction.

8. A method for setting a device control authority, the method being applied to a second Internet of Things device, comprising:
in response to an access request transmitted by the first Internet of Things device based on access information, establishing an access connection relationship between the second cloud server and the first Internet of Things device, wherein the second cloud server is a cloud server having a trust relationship with the second Internet of Things device, the access information is information transmitted by the second Internet of Things device to the first Internet of Things device, and the second Internet of Things device and the first Internet of Things device belong to different Internet of Things systems;
authenticating the first Internet of Things device based on the access connection relationship; and
in response to the authentication being passed, transmitting authentication result information of the first Internet of Things device to the second Internet of Things device to trigger the second Internet of Things device to set authority information for the first Internet of Things device based on the authentication result information.

9. A method for setting a device control authority, the method being applied to a second Internet of Things device, comprising:
transmitting access information for a second cloud server to a first Internet of Things device that has established a connection relationship with the second Internet of Things device, wherein the access information is configured to establish an access connection relationship between the first Internet of Things device and the second cloud server, the access connection relationship is configured for the second cloud server to authenticate the first Internet of Things device, the second cloud server is a cloud server having a trust relationship with the second Internet of Things device, and the second Internet of Things device and the first Internet of Things device belong to different Internet of Things systems;
receiving authentication result information of the first Internet of Things device transmitted by the second cloud server; and
if the authentication result information is that the authentication is passed, setting authority information for the first Internet of Things device.

10. The method of claim 9, wherein the setting of authority information for the first Internet of Things device comprises:
transmitting device control information to the first Internet of Things device to set authority information for the first Internet of Things device with the device control information, wherein the device control information is configured to instruct the first Internet of Things device to set a control authority, the control authority being a device control authority of the second Internet of Things device for the first Internet of Things device.

11. The method of claim 10, further comprising: before the transmitting of the device control information to the first Internet of Things device comprises:
determining device capability information of the first Internet of Things device, comprising:
generating a device capability request for the first Internet of Things device to transmit the device capability request to the first Internet of Things device; and
receiving device capability information returned by the first Internet of Things device based on the device capability request; and
generating device control information for the first Internet of Things device based on the device capability information.

12. The method of claim 11, wherein the generating of the device control information for the first Internet of Things device based on the device capability information comprises:
determining a device control object of the second Internet of Things device, wherein the device control object is an object that controls the first Internet of Things device via the second Internet of Things device; and
generating device control information of the device control object in a target Internet of Things system for the first Internet of Things device based on the device capability information, wherein the target Internet of Things system is an Internet of Things system to which the second Internet of Things device belongs.

13. The method of claim 12, wherein the generating of the device control information of the device control object in the target Internet of Things system for the first Internet of Things device based on the device capability information comprises:
determining a service provided by the first Internet of Things device based on the device capability information;
determining service accessing information of the device control object for the service; and
generating device control information of the device control object in the target Internet of Things system for the first Internet of Things device based on the service accessing information, comprising:
determining object attribute information of the device control object; and
generating device control information of the device control object in the target Internet of Things system for the first Internet of Things based on the object attribute information.

14. The method of claim 9, further comprising:
transmitting a device control instruction to the first Internet of Things to perform device control for the first Internet of Things via the device control instruction.

15. A computer device, comprising: a memory storing a computer program; and a processor, wherein the processor is configured to perform the computer program in the memory to perform the method of claim 1.

16. A computer device, comprising: a memory storing a computer program; and a processor, wherein the processor is configured to perform the computer program in the memory to perform the method of claim 8.

17. A computer device, comprising: a memory storing a computer program; and a processor, wherein the processor is configured to perform the computer program in the memory to perform the method of claim 9.

18. A non-transitory computer readable storage medium storing a computer program which, when executed by a processor, causes the processor to perform the method of claim 1.

19. A non-transitory computer readable storage medium storing a computer program which, when executed by a processor, causes the processor to perform the method of claim 8.

20. A non-transitory computer readable storage medium storing a computer program which, when executed by a processor, causes the processor to perform the method of claim 9.
